(19) United States
(12) Patent Application Publication
(10) Pub. No.: US 2025/0198628 A1
(43) Pub. Date: Jun. 19, 2025

(54) COOKING APPARATUS

(71) Applicant: SAMSUNG ELECTRONICS CO., LTD., Suwon-si (KR)

(72) Inventors: Sooncheol KWEON, Suwon-si (KR); Bokhyun JANG, Suwon-si (KR); Soojong SHIN, Suwon-si (KR); Hanseong KANG, Suwon-si (KR); Moonkyu KIM, Suwon-si (KR); Seungwoo HAN, Suwon-si (KR)

(73) Assignee: SAMSUNG ELECTRONICS CO., LTD., Suwon-si (KR)

(21) Appl. No.: 19/066,668

(22) Filed: Feb. 28, 2025

Related U.S. Application Data
(63) Continuation of application No. PCT/KR2023/012045, filed on Aug. 14, 2023.

(30) Foreign Application Priority Data
Sep. 8, 2022 (KR) 10-2022-0114535
Feb. 3, 2023 (KR) 10-2023-0015113

(51) Int. Cl. F24C 15/02; E05C 3/12; F24C 15/00

(52) U.S. Cl. CPC F24C 15/022; E05C 3/12; F24C 15/006

(57) ABSTRACT

A cooking apparatus includes a main body including a cooking chamber and an electrical chamber partitioned from the cooking chamber, a door configured to open or close the cooking chamber, the door including a hook insertion portion and a plurality of air holes through which air passing through an interior of the door is discharged, and a door opening device arranged in the electrical chamber and configured to open the door, the door opening device including a hook member inserted into the hook insertion portion to lock the door to the main body and withdrawn from the hook insertion portion to unlock the door from the main body, and a drive motor configured to apply a driving force to allow the hook member to be withdrawn from the hook insertion portion.

### CROSS REFERENCE TO THE RELATED APPLICATION

This application is a continuation application, filed under 35 U.S.C. § 111 (a), of International Application PCT/KR2023/012045 filed Aug. 14, 2023, and is based on and claims priority under 35 U.S.C. § 119 to Korean Patent Applications No. 10-2022-0114535, filed on Sep. 8, 2022, and No. 10-2023-0015113, filed on Feb. 3, 2023 in the Korean Intellectual Property Office, the disclosures of which are incorporated by reference herein in their entireties.

### TECHNICAL FIELD

The disclosure relates to a cooking apparatus.

### BACKGROUND ART

In general, a cooking apparatus is an appliance for heating and cooking an object to be cooked, such as food, and that may provide a number of functions related to cooking, such as heating, defrosting, drying, and sterilizing the object to be cooked. Cooking apparatuses include, for example, ovens, such as gas ovens or electric ovens, microwave heating devices (hereinafter referred to as microwaves), gas ranges, electric ranges, over the ranges (OTRs), gas grills, electric grills, and the like.

An oven range is an appliance that cooks food by transferring heat directly to the food or by heating the interior of a cooking chamber through a heating source that generates heat, such as a heater. A microwave is an appliance that cooks food by using high frequency radio waves as a heating source to disturb the molecular arrangement of food, resulting in intermolecular frictional heat.

A cooking apparatus may include a cooking chamber in which food is cooked, and a door arranged to open and close the cooking chamber.

Typically, the door of a cooking apparatus is provided with a handle, and a user may open the door using the handle of the door. The handle of the door may protrude from the door, which may reduce the use of space and the aesthetics of the product. In addition, it may be less user-friendly for the user to open the door by pulling the door directly.

### DISCLOSURE

### Technical Problem

An aspect of the present disclosure provides a cooking apparatus including a door having an improved aesthetics by removing a handle on the door.

An aspect of the present disclosure provides a cooking apparatus including a door capable of opening automatically.

An aspect of the present disclosure provides a cooking apparatus having an improved structure such that a structure holding a door to a main body does not interfere with cooling of the door.

Technical tasks to be achieved in this document are not limited to the technical tasks mentioned above, and other technical tasks not mentioned will be clearly understood by those skilled in the art from the description below.

### Technical Solution

According to an embodiment of the present disclosure, a cooking apparatus includes a main body including a cooking chamber and an electrical chamber partitioned from the cooking chamber at an upper side of the cooking chamber, a door configured to open or close the cooking chamber, the door including a hook insertion portion and a plurality of air holes through which air passing through an interior of the door is discharged, and a door opening device arranged in the electrical chamber and configured to open the door, the door opening device including a hook member inserted into the hook insertion portion to lock the door to the main body and withdrawn from the hook insertion portion to unlock the door from the main body, and a drive motor configured to provide a driving force to allow the hook member to be withdrawn from the hook insertion portion. The hook insertion portion is positioned between the plurality of air holes so as not to interfere with airflow discharged from the plurality of air holes.

The drive motor may include a drive shaft, and the door opening device further comprises a cam member coupled to the drive shaft and configured to rotate together with the drive shaft, and a link member connecting the cam member to the hook member to allow the hook member to rotate in response to a rotation of the cam member.

The door opening device may further comprise a connecting member coupled to the hook member and the link member, the connecting member configured to rotate the hook member in response to a movement of the link member.

The cooking apparatus may further comprises a controller configured to control the door opening device. The door opening device may further comprise a switch configured to transmit a predetermined signal to the controller and including a switch protrusion configured to be pushable.

The switch protrusion may be configured to be intermittently pushed by the cam member in response to the rotation of the cam member.

The hook member may comprise an inclined portion having a width in a left-to-right direction of the hook member that narrows toward a forward.

The hook member may be configured to be withdrawn from the hook insertion portion by rotating in a first direction, and the door opening device may further comprise an elastic member that elastically biases the hook member in a second direction opposite to the first direction.

In response to closing the door, the hook member may be configured to rotate in the first direction by being pressed by the hook insertion portion and then to rotate in the second direction by an elastic force of the elastic member, thereby being inserted into the hook insertion portion.

The door opening device may further comprise a link member configured to be connected to a drive shaft of the drive motor and transmit the driving force of the drive motor to the hook member, the link member including a connecting member insertion portion, and a connecting member including a link coupling portion inserted into the connecting member insertion portion so as to be movable between one end and an other end of the connecting member insertion portion, the connecting member coupled to the hook member. The elastic member may be configured to provide an elastic force to allow the link coupling portion to move toward the one end of the connecting member insertion portion.

Based on the hook member being rotated in the first direction by the drive motor, the link coupling portion may be positioned at the one end of the connecting member insertion portion, and based on the hook member being rotated in the first direction by being pressed by the hook insertion portion, the link coupling portion may be moved from the one end to the other end of the connecting member insertion portion.

The hook insertion portion may comprise a first hook insertion portion and a second hook insertion portion arranged to be spaced apart laterally from an upper end of the door, and the hook member may comprise a first hook member configured to be inserted into the first hook insertion portion; and a second hook member configured to be inserted into the second hook insertion portion.

The plurality of air holes may comprise a first air hole, a second air hole, a third air hole, and a fourth air hole arranged to be laterally spaced apart from the upper end of the door.

The first hook insertion portion may be positioned between the first air hole and the second air hole so as not to interfere with an airflow discharged from the first air hole and the second air hole, and the second hook insertion portion may be positioned between the third air hole and the fourth air hole so as not to interfere with an airflow discharged from the third air hole and the fourth air hole.

The door opening device may further comprise a connecting member configured to connect the first hook member and the second hook member to allow the first hook member and the second hook member to rotate together.

According to an embodiment of the present disclosure, a cooking apparatus includes a main body including a cooking chamber and an electrical chamber partitioned from the cooking chamber at an upper side of the cooking chamber, a door configured to open or close the cooking chamber, the door including a first hook insertion portion and a second hook insertion portion, and a door opening device arranged in the electrical chamber and configured to open the door. The door opening device includes a drive motor configured to rotate a drive shaft, a first hook member inserted into the first hook insertion portion to hold the door to the main body and be withdrawn from the first hook insertion portion to release the door from the main body, a second hook member inserted into the second hook insertion portion to hold the door to the main body and be withdrawn from the second hook insertion portion to release the door from the main body, a connecting member connecting the first hook member and the second hook member to allow the first hook member and the second hook member to rotate together, and a link member connecting the drive shaft and the connecting member to allow the first hook member and the second hook member to rotate in response to rotation of the drive shaft.

### Description of Drawings

FIG. 1 is a perspective view of a cooking apparatus according to an embodiment.

FIG. 2 is a view of the cooking apparatus shown in FIG. 1, with a door open.

FIG. 3 is a view showing an electrical component chamber with an upper panel and a control panel separated, in the cooking apparatus of FIG. 1, according to an embodiment.

FIG. 4 is an enlarged view of portion B of FIG. 3, showing a state before a door opening device unlocks the door.

FIG. 5 is an enlarged view of portion B of FIG. 3, showing a state after the door opening device unlocks the door.

FIG. 6 is an exploded view of the door opening device in the cooking apparatus according to an embodiment.

FIG. 7 is a view of the door alone, in the cooking apparatus according to an embodiment.

FIG. 8 is an enlarged view of portion C of FIG. 7.

FIG. 9 is a cross-sectional view taken along A-A of FIG. 1, showing a state before the door opening device unlocks the door.

FIG. 10 is a cross-sectional view taken along A-A of FIG. 1, showing a state in which the door is being opened in response to the door opening device unlocking the door.

FIG. 11 is a cross-sectional view taken along A-A of FIG. 1, showing a state after the door is opened.

FIG. 12 is a cross-sectional view taken along A-A of FIG. 1, showing a state before the door contacts a hook member when the door is closed.

FIG. 13 is a cross-sectional view taken along A-A of FIG. 1, showing a state in which the hook member is rotated by the door when the open door is closed.

FIG. 14 is a cross-sectional view taken along A-A of FIG. 1, showing a state in which the door is closed and the door opening device holds the door to a main body.

FIG. 15 is a plan view of portion B of FIG. 3, showing a state before the door is opened.

FIG. 16 is a plan view of portion B of FIG. 3, showing a state after the door is unlocked.

FIG. 17 is a view of a door alone, in the cooking apparatus according to an embodiment.

FIG. 18 is a view of a door alone, in the cooking apparatus according to an embodiment.

FIG. 19 is a view of a door alone, in the cooking apparatus according to an embodiment.

FIG. 20 is a view of a door alone, in the cooking apparatus according to an embodiment.

FIG. 21 is a control block diagram of a cooking apparatus according to an embodiment.

FIG. 22 is a flowchart of a method of controlling the cooking apparatus according to an embodiment.

FIG. 23 is a flowchart of a method of controlling the cooking apparatus according to an embodiment.

FIG. 24 is a flowchart of a method of controlling the cooking apparatus according to an embodiment.

FIG. 25 is a flowchart of a method of controlling the cooking apparatus according to an embodiment.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

The terms “front”, “rear”, “left”, “right”, “up (or upper)”, “down (or lower)”, and the like used in the following description are defined with reference to the drawings, but the shape and position of each element are not limited by the above terms.

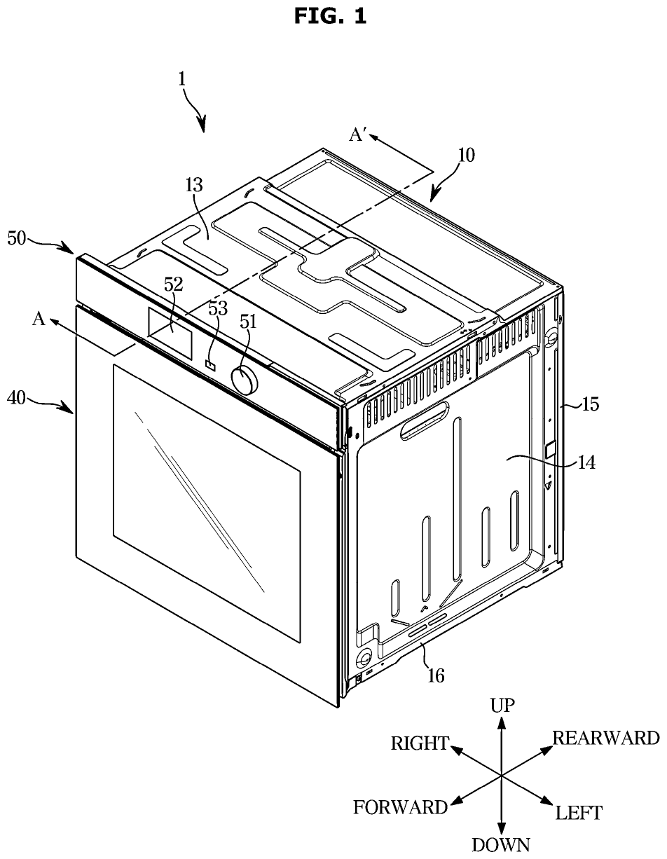

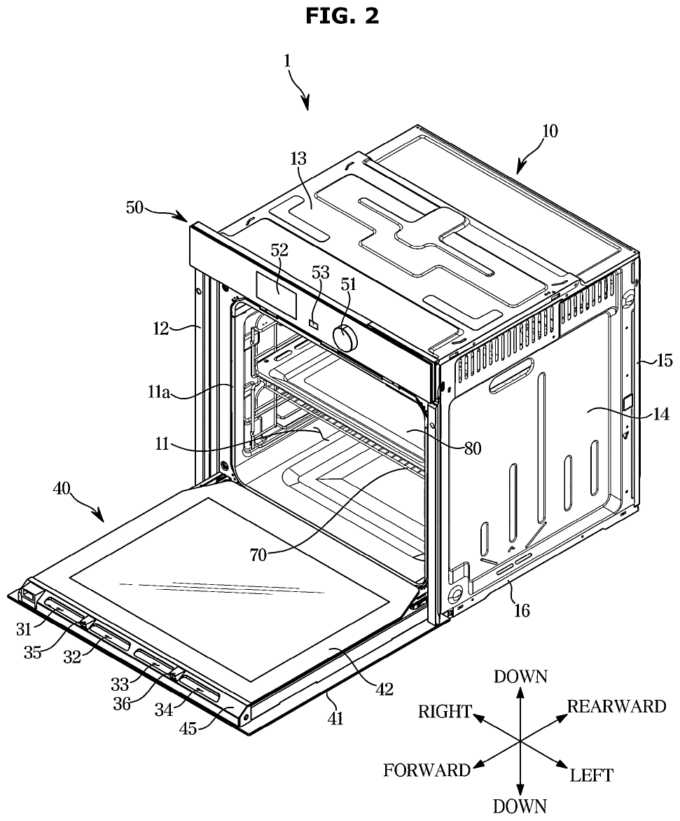

FIG. 1 is a perspective view of a cooking apparatus according to an embodiment. FIG. 2 is a view of the cooking apparatus shown in FIG. 1 with an open door.

The cooking apparatus 1 may be an appliance for heating and cooking an object to be cooked, such as food, and that may provide a number of functions related to cooking, such as heating, defrosting, drying, and sterilizing the object to be cooked. The cooking apparatus 1 may include ovens, such as gas ovens or electric ovens, microwave heating devices (hereinafter referred to as microwaves), gas ranges, electric ranges, over the ranges (OTRs), gas grills, electric grills, and the like. The cooking apparatus 1 may include a heater, hot air, or a magnetron as a heat source.

The cooking apparatus 1 may be mounted on a wall or inside a cabinet so that it is integrated into the kitchen space. In other words, the cooking apparatus 1 may be a built-in type.

The cooking apparatus 1 may include a main body 10 that forms an exterior of the cooking apparatus 1.

A cooking chamber 11 may be provided within the main body 10 to allow food to be cooked to be inserted and food items to be cooked. The cooking chamber 11 may be open at a front side to allow food items to enter and exit the cooking chamber 11. The main body 10 may include an opening 11a for food items to enter and exit the cooking chamber 11 through the open front side thereof. The opening 11a may be formed on a front side of the main body 10.

The main body 10 may include an upper panel 13, a side panel 14, a rear panel 15, and a lower panel 16 that form an exterior of the cooking apparatus 1. The upper panel 13, the side panels 14, the rear panel 15, and the lower panel 16 may each be formed to include a flat plate shape, but are not limited thereto.

The upper panel 13 may be arranged on an upper portion of the main body 10 to form an upper surface of the cooking apparatus 1.

The side panels 14 may be provided in a plurality. For example, the side panels 14 may be provided in a pair, and the pair of side panels 14 may be arranged on the left and right sides of the main body 10, respectively, to form the left and right sides of the cooking apparatus 1.

The rear panel 15 may be arranged on a rear side of the main body 10 to form a rear surface of the cooking apparatus 1.

The side panel 14 and the rear panel 15 may be provided in separate configurations and may be coupled together. Alternatively, the side panel 14 and the rear panel 15 may be integrally formed.

The front of the cooking apparatus 1 may be formed by a door 40 and a control panel 50.

The upper panel 13, the side panels 14, the rear panel 15, and the lower panel 16 may be provided in separate configurations and may be detachably coupled to each other. Alternatively, at least two of the upper panel 13, the side panels 14, the rear panel 15, and the lower panel 16 may be integrally formed.

For example, of the upper panel 13, the side panels 14, the rear panel 15, and the lower panel 16, the upper panel 13 may be arranged to be detachable from the remaining panels. The side panels 14, the rear panel 15, and the lower panel 16 may be integrally formed.

The main body 10 may include a front frame 12 arranged on the front side of the main body 10. The front frame 12 may be formed in the shape of a picture frame covering at least a portion of the front of the main body 10 and including an opening. The front frame 12 may be arranged along a perimeter of the opening 11a of the cooking chamber 11.

The front of the front frame 12 may be covered by the door 40 in response to closing of the door 40.

A plate 80 capable of accommodating food items and a rack 70 for supporting the plate 80 may be provided within the cooking chamber 11. The plate 80 may have a variety of shapes to accommodate food items.

The rack 70 may be configured to be movable in and out of the cooking chamber 11 through the opening 11a of the cooking chamber 11. Specifically, the rack 70 may be slidably moved into or out of the cooking chamber 11.

The cooking apparatus 1 may include the door 40 coupled to the front side of the main body 10.

The door 40 may be configured to open or close the cooking chamber 11. The door 40 may be rotatably coupled to the main body 10 relative to the main body 10.

According to an embodiment, the door 40 may be hinge-coupled to the main body 10 by door hinges (not shown) provided at a lower end of each side of the front of the main body 10. The door 40 may be arranged to rotate about a rotational axis extending laterally from the lower end of the main body 10. The door hinge may be configured to exert a force in a direction of opening of the door 40 such that the door 40 may open on its own when the door 40 is withdrawn from its locking to the main body 10. For example, the door hinge may include an elastic member (not shown) that provides an elastic force in the direction in which the door 40 is opened. Alternatively, the door hinge may not include an elastic member. In this case, the door 40 may open under its own weight when the door 40 is withdrawn from its locking to the main body 10.

The door 40 may be configured to be manually closed based on a user pushing the door 40 toward the main body 10. The door 40 may be configured to be opened automatically by an operating portion 51 of the control panel 50 or a door opening button 53. This will be described later.

The door 40 may be configured to be partially transparent to allow a user to see the interior of the cooking chamber 11 even when the door 40 is closed. The transparent portion of the door 40 may include a heat-resistant glass material, but is not limited thereto.

The door 40 of the cooking apparatus 1 according to the present disclosure may not be formed with a handle. The door 40 may not include a handle protruding from the door 40. By eliminating a handle of the door 40, the cooking apparatus 1 may have a simple appearance, and the aesthetics and the use of space of the cooking apparatus 1 may be improved.

The cooking apparatus 1 may include the control panel 50. The control panel 50 may include the operating portion 51 configured to allow the user to operate functions of the cooking apparatus 1, a display portion 52 configured to display a status of the cooking apparatus 1 to the user, and the door opening button 53 configured to operate a door opening device 100, which will be described later.

The control panel 50 may be arranged on the front side of the cooking apparatus 1 for the convenience of the user, but the present disclosure is not limited thereto.

The user may use the operating portion 51 to set a heating temperature inside the cooking chamber 11, or the like, or to set a method of cooking food items, such as a cooking mode. The operating portion 51 may be configured to operate the door opening device 100. The display portion 52 may display various information required by the user, such as the temperature inside the cooking chamber 11, the cooking mode of food items, and the like. Although the operating portion 51 is shown as a dial type in the drawings, but the present disclosure is not limited thereto. For example, the operating portion may be provided in the form of a touch display. In this case, the operating portion and the display portion may be integrated.

According to an embodiment, the door opening button 53 may be arranged separately from the operating portion 51 and the display portion 52. The door opening button 53 may be provided in the form of a physical button or a touch display. Alternatively, the door opening button 53 may not be provided separately. In this case, the user may operate the door opening device 100 via the operating portion 51.

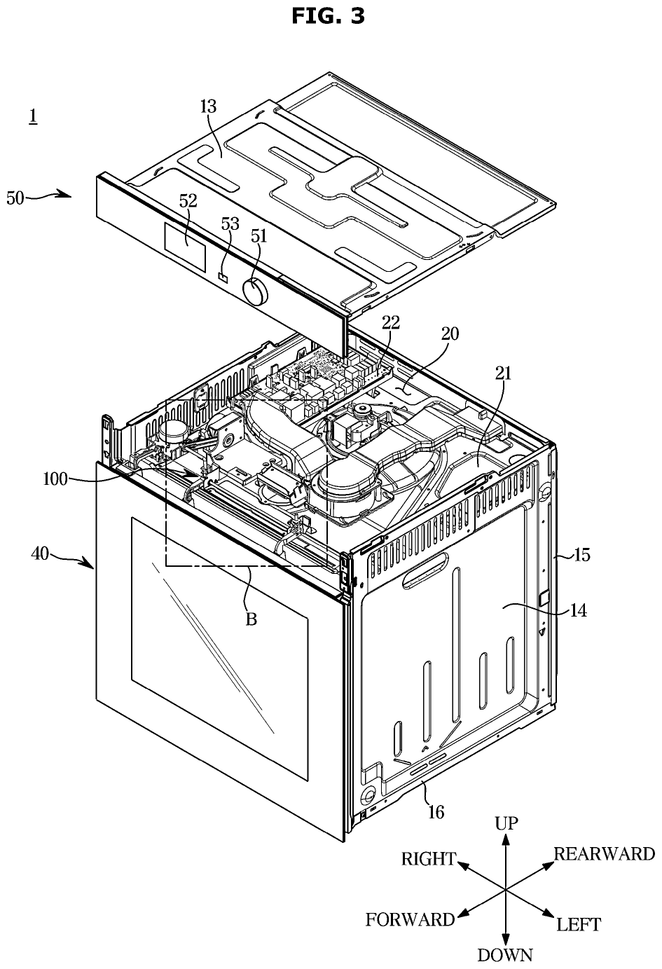

FIG. 3 is a view showing an electrical component chamber in the cooking apparatus according to an embodiment, with the upper panel and the control panel separated.

Referring to FIG. 3, the cooking apparatus 1 may include an electrical component chamber 20 (hereinafter referred to as the electrical chamber) arranged on an upper side of the cooking chamber 11. The electrical chamber 20 may form a space separated from the cooking chamber 11. The electrical component chamber 20 may be arranged on an inner upper portion of the main body 10.

A base plate 21 may be arranged on the cooking chamber 11 of the cooking apparatus 1. The base plate 21 may form a lower surface of the electrical chamber 20. The upper panel 13 of the main body 10 may form an upper surface of the electrical chamber 20. At least a portion of the side panels 14 and the rear panel 15 of the main body 10 may form the side and rear surfaces of the electrical chamber 20. Hereinafter, the upper panel 13 may be referred to as an electrical chamber cover 13.

Various electrical components including a circuit board 22 for controlling the operation of the cooking apparatus 1 may be arranged in the electrical chamber 20. A plurality of electrical components may be mounted, fixed, or coupled to the base plate 21 forming the lower surface of the electrical chamber 20.

The electrical components including the circuit board 22 may be supplied with power from an external power source or be connected to each other by wires (not shown). The electrical components may be supplied with power through the wires, in addition to exchanging electrical signals with each other to perform the functions of the cooking apparatus 1.

The cooking apparatus 1 according to the present disclosure may include the door opening device 100. The door opening device 100 may be configured to open a door 40 in a closed state.

The door opening device 100 may be arranged in the electrical chamber 20. The door opening device 100 may be mounted or installed on the base plate 21. The door opening device 100 may be arranged on a front side of the base plate 21 so as to be adjacent to the door 40. The door opening device 100 may be arranged on the front side of the electrical chamber 20.

The door opening device 100 may be configured to open the door 40. The door opening device 100 may be configured to open the door 40 by input from the user via the door opening button 53 on the control panel 50 or the operating portion 51. The door opening device 100 may be configured to automatically open the door 40 of the cooking apparatus 1. The door opening device 100 may allow the user to open the door 40 without directly pulling the door 40. In a case where the door 40 is opened by the door opening device 100, the door 40 may not be provided with a handle because the user does not need to pull the door 40. Removing the handle from the door 40 may simplify the appearance of the cooking apparatus 1.

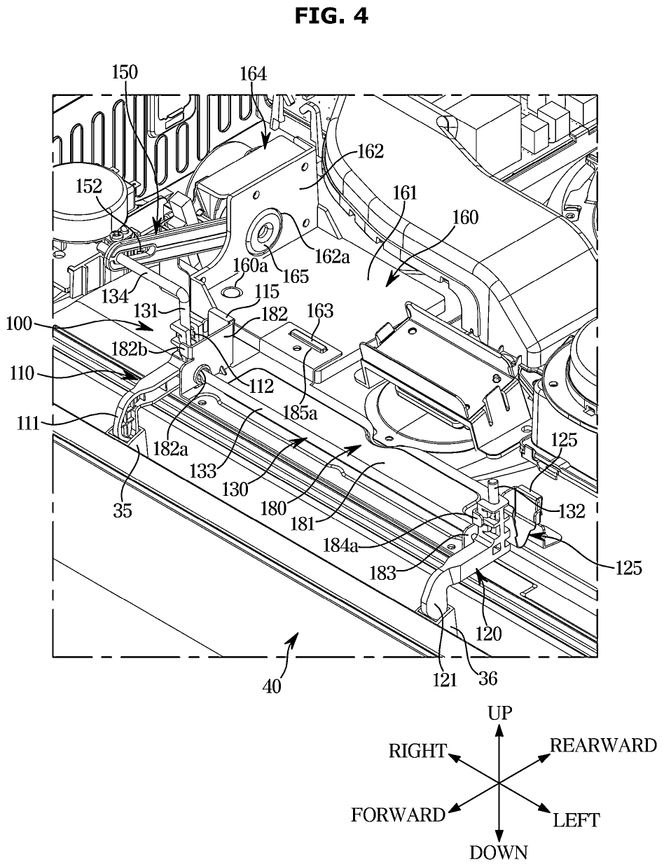

FIG. 4 is an enlarged view of portion B of FIG. 3, showing a condition of the door before the opening device unlocks the door.

Referring to FIG. 4, the door 40 may include hook insertion portions 35 and 36. According to an embodiment, the hook insertion portions 35 and 36 may include a first hook insertion portion 35 and a second hook insertion portion 36. However, the present disclosure is not limited thereto. The hook insertion portions may be provided in three or more or may be provided in one.

The door opening device 100 may include hook members 110 and 120 including hooks 111 and 121 configured to be inserted into the hook insertion portions 35 and 36 of the door 40, respectively. According to an embodiment, the hook members 110 and 120 may include a first hook member 110 and a second hook member 120. However, the number of hook members is not limited thereto. The hook member may be provided in three or more or may be provided in one. The position and number of the hook members and the hook insertion portions may be arranged to correspond.

The door opening device 100 may include the hooks 111 and 121 configured to be inserted into the hook insertion portions 35 and 36 of the door 40 to allow the door 40 to be maintained in a closed state. In response to the hooks 111 and 121 being inserted into the hook insertion portions 35 and 36 arranged in the door 40, the door 40 may remain in the closed state without being opened.

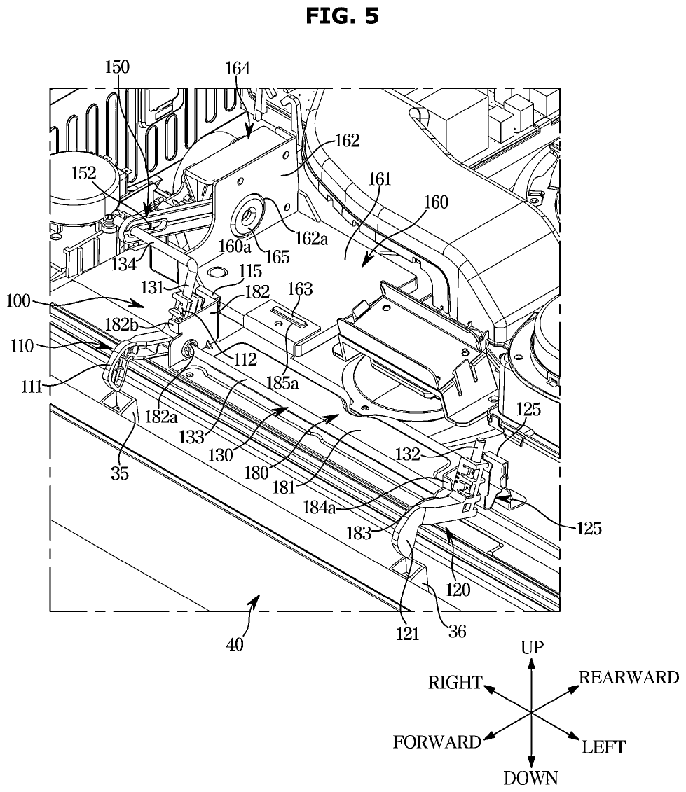

FIG. 5 is an enlarged view of portion B of FIG. 3, showing a condition of the door after the door opening device unlocks the door.

Referring to FIG. 5, the door opening device 100 may open the door 40 by releasing the hooks 111 and 121 from the hook insertion portions 35 and 36. The door opening device 100 may rotate the hooks 111 and 121 such that the hooks 111 and 121 are withdrawn (e.g., unlocked) from the hook insertion portions 35 and 36. After the hooks 111 and 121 are rotated and withdrawn from the hook insertion portions 35 and 36, the door 40 may open automatically under its own weight or the door hinges.

As described above, based on the hooks 111 and 121 being inserted into the hook insertion portions 35 and 36, the door 40 may be held or locked to the main body 10 by the hooks 111 and 121 to maintain the door 40 in the closed state. After the hooks 111 and 121 are withdrawn from the hook insertion portions 35 and 36, the holding or locking of the door 40 and the main body 10 is withdrawn, allowing the door 40 to open automatically under its own weight or the door hinges.

According to an embodiment, the door opening device 100 may include two hook members 110 and 120 and two hook insertion portions 35 and 36, thereby reliably locking the door 40 to the main body 10 as compared to a structure in which only one hook member and one hook insertion portion are provided each.

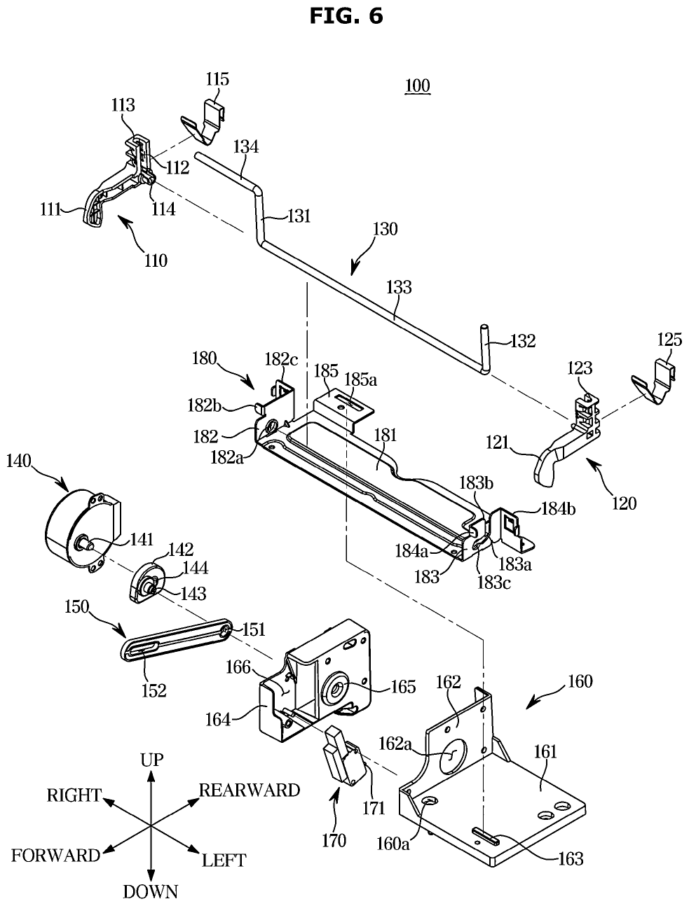

FIG. 6 is an exploded view of the door opening device in the cooking apparatus according to an embodiment.

In the following, the structure of the door opening device 100 will be described in detail with reference to FIG. 6.

The door opening device 100 may include the first hook member 110 including a first hook 111 configured to be inserted into the first hook insertion portion 35 of the door 40, and the second hook member 120 including a second hook 121 configured to be inserted into the second hook insertion portion 36 of the door 40.

The door opening device 100 may include a connecting member 130 connecting the first hook member 110 and the second hook member 120 to allow the first hook member 110 and the second hook member 120 to be moved together. The connecting member 130 may be coupled to the first hook member 110 and the second hook member 120, respectively. The connecting member 130 may include a first coupling portion 131 coupled with the first hook member 110, a second coupling portion 132 coupled with the second hook member 120, and a connecting portion 133 connecting the first coupling portion 131 and the second coupling portion 132. The connecting member 130 may include a link coupling portion 134 coupled with a link member 150.

According to an embodiment, the connecting portion 133 may extend along a horizontal direction. More particularly, the connecting portion 133 may extend laterally along the horizontal direction. The first coupling portion 131 may be arranged at one end of the connecting portion 133. The second coupling portion 132 may be arranged at the other end of the connecting portion 133.

The first coupling portion 131 may be formed by bending from one end of the connecting portion 133. The first coupling portion 131 may be formed by bending from one end of the connecting portion 133 in a substantially vertical direction.

The second coupling portion 132 may be formed by bending from the other end of the connecting portion 133. The second coupling portion 132 may be formed by bending from the other end of the connecting portion 133 in the substantially vertical direction. The first coupling portion 131 and the second coupling portion 132 may be arranged substantially in parallel. Such a structure may allow the first hook member 110 coupled to the first coupling portion 131 and the second hook member 120 coupled to the second coupling portion 132 to be simultaneously inserted into the first hook insertion portion 35 and the second hook insertion portion 36 or be withdrawn from the first hook insertion portion 35 and the second hook insertion portion 36.

The link coupling portion 134 may be arranged at one end of the first coupling portion 131. The link coupling portion 134 may be formed by bending from one end of the first coupling portion 131. The link coupling portion 134 may be formed by bending in the approximately vertical direction from one end of the first coupling portion 131. The link coupling portion 134 may be arranged at one end of the first coupling portion 131, and the connecting portion 133 may be arranged at the other end of the first coupling portion 131.

The first hook member 110 may include the first hook 111 configured to be inserted into the first hook insertion portion 35 or to be withdrawn from the first hook insertion portion 35. The first hook member 110 may include a first coupling groove 112 configured to be coupled with the first coupling portion 131 of the connecting member 130. The connecting member 130 and the first hook member 110 may be coupled by inserting the first coupling portion 131 into the first coupling groove 112.

A first end 113 of the first coupling groove 112 may be open. The first coupling portion 131 may protrude from the first hook member 110 through the first end 113 of the open first coupling groove 112. At a second end of the first coupling groove 112, a first coupling portion insertion groove 114 may be provided into which at least a portion of the connecting portion 133 may be inserted. The first coupling portion insertion groove 114 may become a rotational axis of the first hook member 110. The first hook member 110 may rotate around the connecting member 133 inserted into the first coupling portion insertion groove 114 as a rotational axis.

The second hook member 120 may be arranged to be symmetrical from side to side with the first hook member 110. The second hook member 120, similar to the first hook member 110, may include the second hook 121 configured to be inserted into the second hook insertion portion 36 or be withdrawn from the second hook insertion portion 36. The second hook member 120 may include a second coupling groove (not shown) configured to be coupled with the second coupling portion 132 of the connecting member 130. The connecting member 130 and the second hook member 120 may be coupled by inserting the second coupling portion 132 into the second coupling groove.

A first end 123 of the second coupling groove may be open. The second coupling portion 132 may protrude from the second hook member 120 through the first end 123 of the open second coupling groove. At a second end of the second coupling groove, a second coupling portion insertion groove (not shown) may be provided into which at least a portion of the connecting portion 133 is inserted. The second coupling portion insertion groove may become a rotational axis of the second hook member 120. The second hook member 120 may rotate around the connecting portion 133 inserted into the second coupling portion insertion groove as a rotational axis.

The door opening device 100 may include a drive motor 140 that provides a driving force to rotate the first hook member 110 and the second hook member 120. The drive motor 140 may include a drive shaft 141 configured to rotate in response to operation of the drive motor 140. The drive shaft 141 may be configured such that a circumferential portion of the drive shaft 141 is flat. In other words, the drive shaft 141 may be provided in a D-cut type. The D-cut type of the drive shaft 141 may allow a cam member 142 coupled to the drive shaft 141 to rotate together with the drive shaft 141. The cam member 142 coupled to the drive shaft 141 may not rotate relative to the drive shaft 141.

The door opening device 100 may include the cam member 142. The cam member 142 may be coupled to the drive shaft 141 and may rotate together with the drive shaft 141. The cam member 142 may include a shaft insertion portion 144 provided in a shape corresponding to the drive shaft 141 for insertion of the drive shaft 141. The shaft insertion portion 144 may also be provided in a D-cut shape corresponding to the drive shaft 141.

The cam member 142 may include a link connecting portion 143 arranged at a predetermined distance from the shaft insertion portion 144. The link connecting portion 143 may be formed to protrude from one face of the cam member 142 toward the link member 150. The link connecting portion 143 may be formed to protrude in a direction in which the drive shaft 141 extends from one face of the cam member 142. The link connecting portion 143 may have a circular cross-sectional shape so as to be rotatable within a cam insertion portion 151 of the link member 150. The link connecting portion 143 may be provided on one face of the cam member 142, and the shaft insertion portion 144 may be provided on the other face of the cam member 142. Accordingly, the link member 150 may be coupled to one side of the cam member 142, and the drive motor 140 may be coupled to the other side of the cam member 142.

The door opening device 100 may include the link member 150 configured to transmit the driving force of the drive motor 140 to the connecting member 130, the first hook member 110, and the second hook member 120. The link member 150 may be coupled to the cam member 142 and the connecting member 130.

The link member 150 may include the cam insertion portion 151 into which the link connecting portion 143 of the cam member 142 is inserted, and a connecting member insertion portion 152 into which the link coupling portion 134 of the connecting member 130 is inserted.

The link member 150 may extend along one direction. The link member 150 may be arranged to extend along a front-to-back direction. The cam insertion portion 151 may be arranged on one side of the link member 150. The connecting member insertion portion 152 may be arranged on the other side of the link member 150. The cam insertion portion 151 may include a groove or hole into which the link connecting portion 143 of the cam member 142 is inserted. The connecting member insertion portion 152 may include a groove or hole into which the link coupling portion 134 of the connecting member 130 is inserted.

According to an embodiment, the cam insertion portion 151 may refer to a hole into which the link connecting portion 143 is inserted. The connecting member insertion portion 152 may refer to a hole into which the link coupling portion 134 is inserted. The connecting member insertion portion 152 may extend along a direction in which the link member 150 extends.

The link connecting portion 143 may be rotatable relative to the cam insertion portion 151 within the cam insertion portion 151. To this end, the link connecting portion 143 may be provided with a circular cross-sectional shape, and the cam insertion portion 151 may be provided with a circular hole corresponding to the link connecting portion 143. The diameter of the cam insertion portion 151 may be arranged to be larger than the outer diameter of the link connecting portion 143 so that the link connecting portion 143 may rotate relative to the cam insertion portion 151 within the cam insertion portion 151.

The link coupling portion 134 may be rotatable within the connecting member insertion portion 152. The link coupling portion 134 may be movable within the connecting member insertion portion 152 along the direction in which the connecting member insertion portion 152 extends. The link coupling portion 134 may move from one end of the connecting member insertion portion 152 to the other end or from the other end to the one end in response to operation of the drive motor 140. In response to the link coupling portion 134 moving from one end of the connecting member insertion portion 152 to the other end or from the other end to the one end, the link coupling portion 134 may rotate relative to the connecting member insertion portion 152 within the connecting member insertion portion 152.

The door opening device 100 may include a base bracket 160 coupled to the base plate 21 and a support bracket 164 coupled to the base bracket 160.

The base bracket 160 may include a plate portion 161 arranged to be coupled on the base plate 21 and a bracket support portion 162 protruding upwardly from one end of the plate portion 161.

The plate portion 161 may be provided with a fastening hole 160a, and a fastening member (not shown) may be fastened to the base plate 21 by penetrating the fastening hole 160a, so that the base bracket 160 may be coupled to the base plate 21.

The plate portion 161 may include an assembly protrusion 163 configured to be inserted into an assembly hole 185a of a hook support member 180, which will be described later. The assembly protrusion 163 may be formed by at least a portion of the plate portion 161 protruding upwardly. The assembly protrusion 163 may be provided in a shape corresponding to the assembly hole 185a. By inserting the assembly protrusion 163 into the assembly hole 185a, the assembly position of the hook support member 180 with respect to the base plate 21 may be easily located and secured.

The bracket support portion 162 may be formed by protruding upwardly from one end of the plate portion 161. The support bracket 164 may be coupled to the bracket support portion 162. The bracket support portion 162 may include a guide portion insertion hole 162a into which a guide portion 165 of the support bracket 164 is inserted.

The support bracket 164 may be configured to support the drive motor 140. The support bracket 164 may be configured to support a switch 170. The support bracket 164 may include the guide portion 165 configured to guide movement of the link connecting portion 143 of the cam member 142.

The door opening device 100 may include the switch 170. The switch 170 may include a switch protrusion 171 configured to be retractable inwardly of the switch 170 and protruding outwardly of the switch 170.

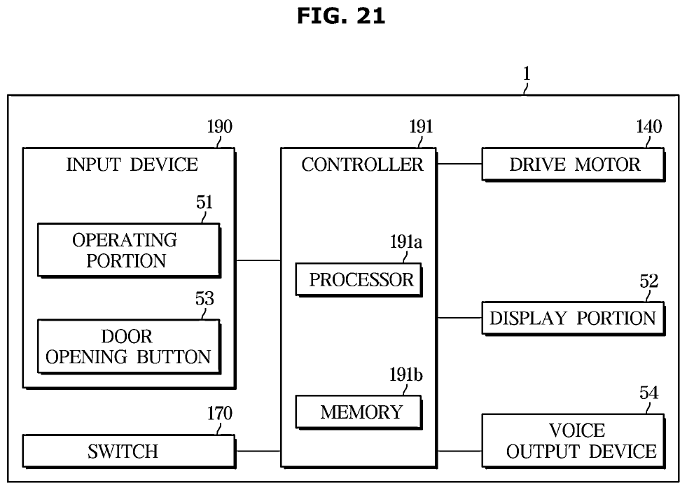

The switch 170 may be configured to transmit a given signal to a controller 191 (see FIG. 21) configured to control the cooking apparatus 1 when the switch protrusion 171 protruding outwardly of the switch 170 is retracted inwardly into the switch 170. The switch 170 may be configured to transmit a given signal to the controller 191 configured to control the cooking apparatus 1 when the switch protrusion 171 retracted inwardly into the switch 170 protrudes outwardly of the switch 170.

According to an embodiment, the switch protrusion 171 pushed by the cam member 142 and retracted inwardly into the switch 170 may protrude outwardly from the switch 170 in response to rotation of the cam member 142. Based on the switch protrusion 171 protruding outwardly from the switch 170 due to the rotation of the cam member 142, the switch 170 may transmit a signal to the controller 191 indicating that the door 40 is being opened. As the cam member 142 continues to rotate in a state where the switch protrusion 171 protrudes outwardly from the switch 170, the cam member 142 may press the switch protrusion 171 to retract the switch protrusion 171 inwardly into the switch 170. Based on the switch protrusion 171 being retracted inwardly into the switch 170 by the rotation of the cam member 142, the switch 170 may transmit a signal to the controller 191 indicating that the opening of the door 40 is complete.

The switch 170 may be coupled to the support bracket 164. The switch 170 may be secured to a switch receiving portion 166 of the support bracket 164. Based on the support bracket 164 being coupled to the base bracket 160, the switch 170 may be arranged between the support bracket 164 and the bracket support portion 162 of the base bracket 160.

The switch 170 may be arranged such that the switch protrusion 171 is pushed by the cam member 142. Specifically, the switch 170 may be arranged such that the switch protrusion 171 is pushed by the cam member 142 before the drive motor 140 is actuated. The switch protrusion 171 pushed by the cam member 142 may be arranged to remain in a state in which the switch protrusion 171 is retracted inwardly into the switch 170. The switch 170 may be configured such that, as the cam member 142 rotates in response to the operation of the drive motor 140, the switch protrusion 171 retracted inwardly into the switch 170 may be extracted outward. The switch protrusion 171 may remain extracted from the switch 170 until the cam member 142 rotates 360 degrees to press the switch protrusion 171 again. Based on the switch protrusion 171 being extracted outward from the switch 170, the switch 170 may transmit a signal to the controller 191 indicating that the door 40 is being opened.

According to an embodiment, one side of the guide portion 165 may be provided as a ring-shaped groove to guide rotational movement of the link connecting portion 143. The other side of the guide portion 165 may protrude from one side of the support bracket 164 in an approximately ring shape. The other side of the guide portion 165 protruding from one side of the support bracket 164 may be inserted into the guide portion insertion hole 162a of the base bracket 160.

The door opening device 100 may include the hook support member 180 configured to be coupled to the base plate 21 and to support the first hook member 110 and the second hook member 120.

The hook support member 180 may include a base portion 181 coupled to the base plate 21, a first hook support portion 182 and a second hook support portion 183 arranged on opposite sides of the base portion 181. In addition, the hook support member 180 may further include a position guide portion 185 arranged on one side of the base portion 181. The position guide portion 185 may include the assembly hole 185a described above. The position guide portion 185 may be arranged on a rear side of the base portion 181. The position guide portion 185 may be formed by bending from the base portion 181. As described above, by inserting the assembly protrusion 163 of the base bracket 160 into the assembly hole 185a of the position guide portion 185, the coupling position of the hook support member 180 relative to the base plate 21 may be easily located and secured.

The first hook support member 182 may be arranged on one side of the base portion 181. The first hook support member 182 may be formed by bending one side end of the base portion 181 upwardly. The first hook support member 182 may include a first insertion hole 182a arranged to allow the second coupling portion 132 and the connecting portion 133 to pass therethrough. The connecting portion 133 may be inserted into the first insertion hole 182a. The connecting portion 133 may rotate within the first insertion hole 182a. To allow the connecting portion 133 to rotate within the first insertion hole 182a, the diameter of the first insertion hole 182a may be arranged to be larger than the outer diameter of the connecting portion 133.

When the connecting member 130 may be rotated approximately 90 degrees after inserting the second coupling portion 132 of the connecting member 130 into the first insertion hole 182a, the second coupling portion 132 may penetrate the first insertion hole 182a. After the second coupling portion 132 penetrates the first insertion hole 182a, the connecting portion 133 may be coupled to the hook support member 180 by pulling the connecting portion 133 toward the second hook support portion 183, and inserting the connecting portion 133 adjacent to the second hook connecting portion into a hook coupling groove 183a.

The first hook support portion 182 may include a first stopper 182b configured to limit a rotational range of the first hook member 110. In addition, the first hook support member 182 may include a first elastic member support portion 182c configured to support a first elastic member 115 that elastically biases the first hook member 110 in one direction. The first elastic member 115 may press the first hook member 110 to rotate the first hook member 110 in a second direction.

The second hook support portion 183 may be arranged on the other side of the base portion 181. The second hook support portion 183 may be formed by bending the other side end of the base portion 181 upwardly. The second hook support portion 183 may include the hook coupling groove 183a into which the connecting portion 133 adjacent to the second coupling portion 132 is inserted. One end 183b of the hook coupling groove 183a may be open for insertion of the connecting portion 133. The other end of the hook coupling groove 183a may be provided with a second insertion hole 183c into which the connecting portion 133 may be rotatably inserted. The connecting portion 133 inserted through the one end 183b of the hook coupling groove 183a may be moved from the one end 183b of the hook coupling groove 183a to the other end of the hook coupling groove 183a and be positioned within the second insertion hole 183c.

The second hook support portion 183 may include a second stopper 184a configured to limit the rotational range of the second hook member 120. In addition, the second hook support portion 183 may include a second elastic member support portion 184b configured to support a second elastic member 125 that elastically biases the second hook member 120 in one direction. The second elastic member 125 may press the second hook member 120 such that the second hook member 120 rotates in the second direction.

The door opening device 100 may include the first elastic member 115 and the second elastic member 125.

The first elastic member 115 may elastically bias the first hook member 110 in the second direction. The first elastic member 115 may provide an elastic force to the first hook member 110 such that the first hook member 110 rotates in the second direction in which the first hook member 110 is inserted into the first hook insertion portion 35. The first elastic member 115 may be configured to be fitted into the first elastic member support portion 182c. The first elastic member 115 may be configured to press the first coupling groove 112 of the first hook member 110 forwardly.

The second elastic member 125 may elastically bias the second hook member 120 in the second direction. The second elastic member 115 may provide an elastic force to the second hook member 110 such that the second hook member 120 rotates in the second direction in which the second hook member 120 is inserted into the second hook insertion portion 36. The second elastic member 125 may be configured to be fitted into the second elastic member support portion 184b. The second elastic member 125 may be configured to press the second coupling groove of the second hook member 120 forwardly.

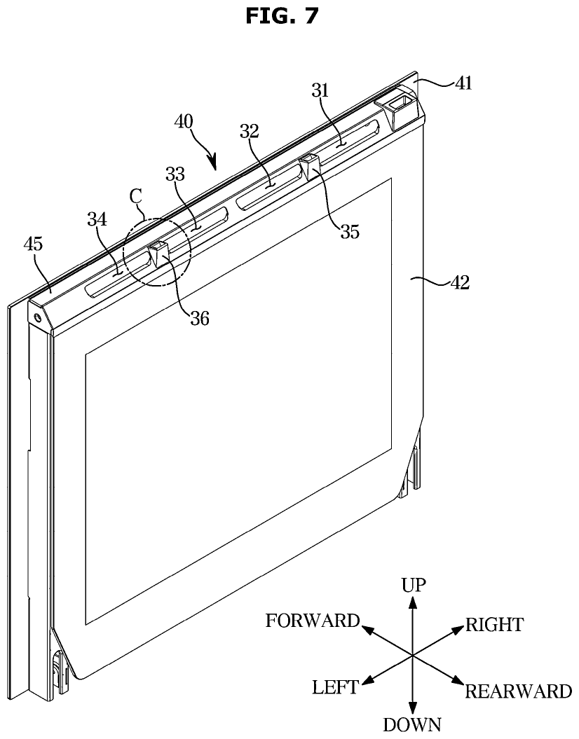

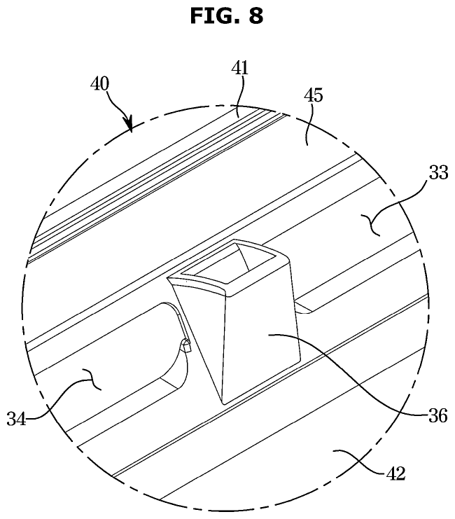

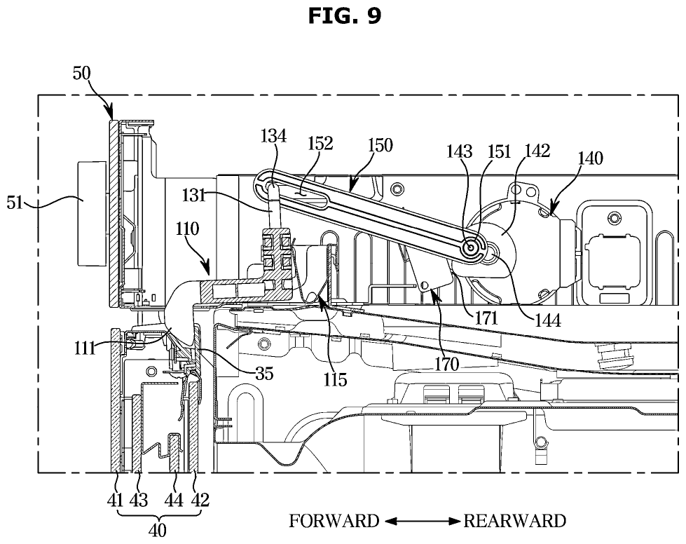

FIG. 7 is a view showing a door alone in the cooking apparatus according to an embodiment. FIG. 8 is an enlarged view of portion C of FIG. 7. FIG. 9 is a cross-sectional view taken along A-A of FIG. 1, showing a condition before the door opening device unlocks the door.

Referring to FIG. 1, the door 40 of the cooking apparatus 1 according to an embodiment may include an outer glass 41. The outer glass 41 may form the front exterior of the door 40. The outer glass 41 may be disposed in the same plane as the control panel 50. A surface of the outer glass 41 may be exposed to the user.

The outer glass 41 may be provided with an opaque edge and a transparent enter. This may allow the user to view the interior of the cooking chamber 11 from the outside of the door 40.

Referring to FIG. 2, the door 40 may include an inner glass 42. The inner glass 42 may be arranged on a rear side of the outer glass 41 so as to face the cooking chamber 11.

Referring to FIG. 9, the outer glass 41 and the inner glass 42 may be arranged to be spaced apart from each other in the front-to-back direction. A given gap may be formed between the outer glass 41 and the inner glass 42.

The door 40 may include middle glasses 43 and 44. The middle glasses 43 and 44 may include a first middle glass 43 and a second middle glass 44, but are not limited thereto. The middle glass may be one.

The middle glasses 43 and 44 may be positioned between the outer glass 41 and the inner glass 42 to improve the thermal insulation of the door 40. For example, the middle glasses 43 and 44 may be configured to block or reduce the high temperature inside the cooking chamber 40 from being transferred from the inner glass 42 to the outer glass 41. In addition, the middle glasses 43 and 44, together with the outer glass 41 and the inner glass 42, may form a channel for air to flow between the outer glass 41 and the inner glass 42.

Referring to FIG. 7, the door 40 may include a door duct 45. The door duct 45 may be positioned between the outer glass 41 and the inner glass 42. The door duct 45 may be arranged at a rear upper portion of the outer glass 41. The door duct 45 may be arranged at an upper end of the door 40 to form an upper surface of the door 40.

The door duct 45 may be configured to discharge air flowing between the outer glass 41 and the inner glass 42 to the outside of the door 40. The door duct 45 may include a plurality of air holes 31, 32, 33 and 34 configured to discharge air between the outer glass 41 and the inner glass 42 to the outside of the door 40. The plurality of air holes 31, 32, 33 and 34 may include a first air hole 31, a second air hole 32, a third air hole 33, and a fourth air hole 34.

The door 40 may include the first hook insertion portion 35 and the second hook insertion portion 36. Referring to FIGS. 7 and 8, the first hook insertion portion 35 and the second hook insertion portion 36 may each be positioned between the plurality of air holes 31, 32, 33 and 34. Specifically, the first hook insertion portion 35 may be positioned between the first air hole 31 and the second air hole 32. The second hook insertion portion 36 may be positioned between the third air hole 33 and the fourth air hole 34. As such, by positioning the hook insertion portions 35 and 36 between the plurality of air holes 31, 32, 33 and 34, the hook insertion portions 35 and 36 may not obstruct the flow of air discharged through the plurality of air holes 31, 32, 33 and 34. In other words, by positioning the hook insertion portions 35 and 36 between the plurality of air holes 31, 32, 33 and 34, the interference between the hook insertion portions 35 and 36 and the door cooling airflow discharged through the plurality of air holes 31, 32, 33 and 34 may be reduced. Accordingly, the hook insertion portions 35 and 36 may avoid interfering with the cooling of the door 40 or reducing the cooling speed of the door 40.

An air inlet (not shown) may be arranged at the lower end of the door 40 to allow air to enter a gap formed between the outer glass 41 and the inner glass 42. Outside air introduced between the outer glass 41 and the inner glass 42 through the air inlet formed at the lower end of the door 40 may be heated as it flows between the outer glass 41 and the inner glass 42. The air, the density of which is lowered as a result of being heated between the outer glass 41 and the inner glass 42, may be allowed to move upward and exit from the upper end of the door 40. Specifically, the air between the outer glass 41 and the inner glass 42 may be discharged to the outside of the door 40 through the first to fourth air holes 31, 32, 33 and 34. As the outside air introduced through the lower end of the door 40 flows through the interior of the door 40 and then is discharged through the upper end of the door 40, the door 40 may be cooled. As the door 40 is cooled, the surface temperature of the outer glass 41 may be maintained below a given temperature. This may prevent the user from being burned by contacting with the surface of the outer glass 41.

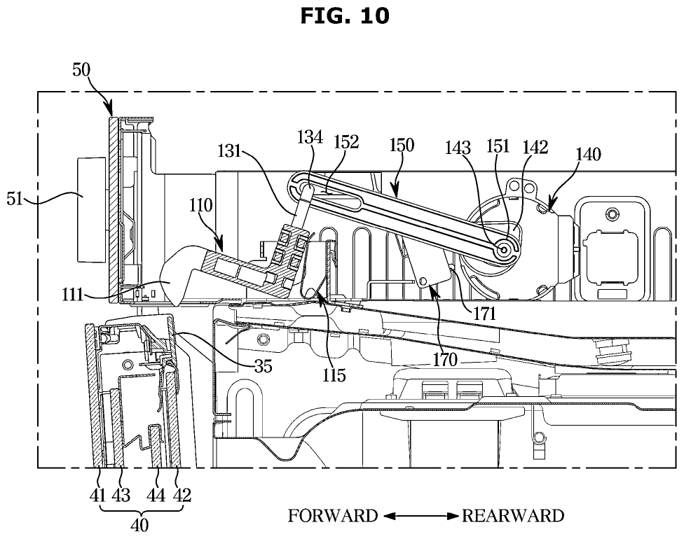

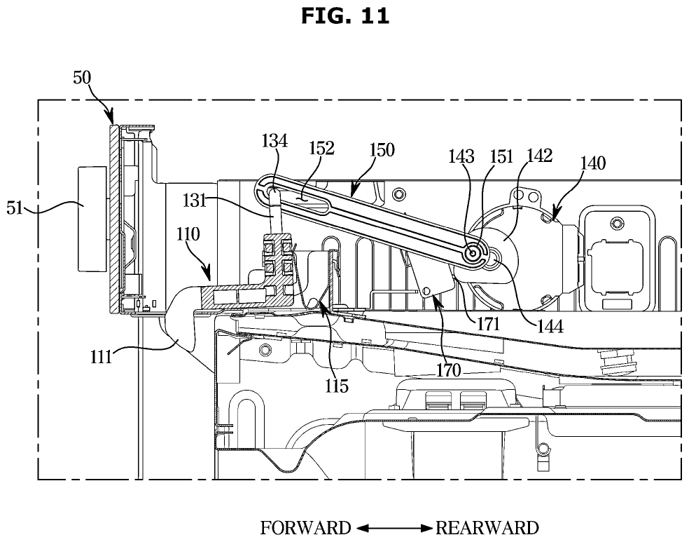

FIG. 9 is a cross-sectional view taken along A-A of FIG. 1, showing a condition before the door opening device unlocks the door. FIG. 10 is a cross-sectional view taken along A-A of FIG. 1, showing a condition in which the door is being opened in response to the door opening device unlocking the door. FIG. 11 is a cross-sectional view taken along A-A of FIG. 1, showing a condition after the door is opened.

In the following, with reference to FIGS. 9 to 11, an operation of the door opening device 100 of the cooking apparatus 1 according to the present disclosure will be described in detail. FIGS. 9 to 11 show cross-sectional views of the first hook member 110, and thus the operation of the first hook member 110 will be described. The second hook member 120 may operate identically to the first hook member 110, and a description thereof will be omitted.

Referring to FIG. 9, when the first hook 111 is inserted into the first hook insertion portion 35 of the door 40, the door 40 may be maintained in a state of being held to the main body 10. When the first hook 111 is inserted into the first hook insertion portion 35, the first hook 111 may prevent the door 40 from being opened. Accordingly, the door 40 may be maintained in the closed state without being opened.

In response to the door 40 being closed, the switch protrusion 171 of the switch 170 may be pushed by the cam member 142. The switch protrusion 171 may be pushed by the cam member 142 to remain retracted inwardly into the switch 170.

In response to the door 40 being closed, the link coupling portion 134 of the connecting member 130 may be positioned at one end of the connecting member insert portion 152 of the link member 150.

Referring to FIG. 10, in response to the user inputting an automatic door opening signal via the door opening button 53 of the control panel 50, the controller 191 may operate the drive motor 140. In response to operation of the drive motor 140, the drive shaft 141 and the cam member 142 coupled to the drive shaft 141 and rotating together with the drive shaft 141 may rotate.

In response to rotation of the cam member 142, the link member 150 may be moved by the rotation of the cam member 142. The cam member 142 may rotate around the shaft insertion portion 144 into which the drive shaft 141 is inserted. In response to the rotation of the cam member 142, the link connecting portion 143 spaced apart from the shaft insertion portion 144 may revolve around the shaft insertion portion 144. In response to revolving of the link connecting portion 143 around the shaft insertion portion 144, the cam insertion portion 151 of the link member 150 may revolve around the shaft insertion portion 144. In response to the cam insertion portion 151 revolving around the shaft insertion portion 144, the link member 150 may move rearwardly and the first hook member 110 may rotate. The first hook member 110 may rotate in a first direction in which the first hook 111 is pulled out of the first hook insertion portion 35. In response to the first hook member 110 rotating in the first direction, the first hook 111 may be withdrawn from the first hook insertion portion 35, thereby unlocking the door 40. In response to the door 40 being unlocked, the door 40 may open automatically under its own weight.

Referring to FIG. 10, when the first hook 111 is withdrawn from the first hook insertion portion 35, the switch protrusion 171 of the switch 170 may not be pushed by the cam member 142. As a result, the switch protrusion 171 may protrude outwardly from the switch 170. In response to the switch protrusion 171 retracted inwardly into the switch 170 protruding outwardly from the switch 170, the switch 170 may transmit a signal to the controller 191 indicating that the door is opened.

When the door 40 is unlocked, the link coupling portion 134 of the connecting member 130 may be positioned at one end of the connecting member insertion portion 152 of the link member 150. The first elastic member 115 may provide an elastic force to cause the first hook member 110 to face one end of the connecting member insertion portion 152.

Referring to FIG. 11, the drive motor 140 may be controlled to operate until the cam member 142 presses the switch protrusion 171. The drive motor 140 may be controlled to operate until the cam member 142 presses the switch protrusion 171 such that the switch protrusion 171 is retracted inwardly into the switch 170. In other words, in response to the cam member 142 rotating approximately 360 degrees to press the switch protrusion 171 again, the switch protrusion 171 may be retracted inwardly into the switch 170, and the switch 170 may transmit a signal to the controller 191 indicating that the opening of the door is complete. As such, the switch protrusion 171 may be arranged to be pushed intermittently as the cam member 142 rotates. Upon receiving a door opening completion signal, the controller 191 may control the drive motor 140 so that the drive motor 140 does not operate. The first hook member 110 may return to its original position before the door 40 is opened.

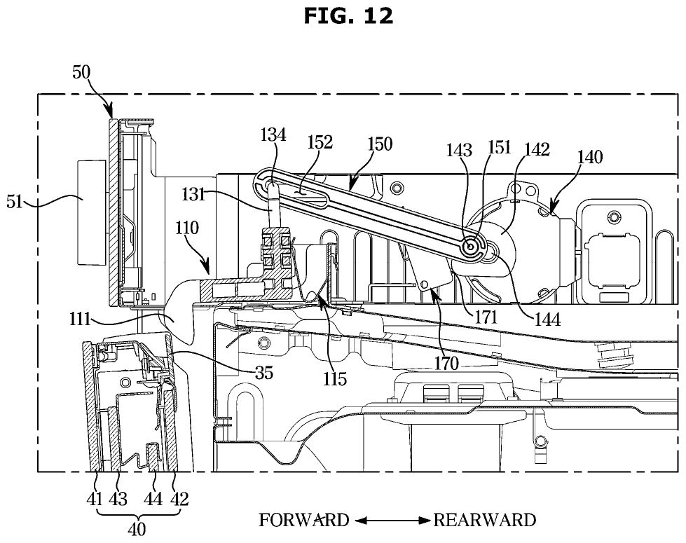

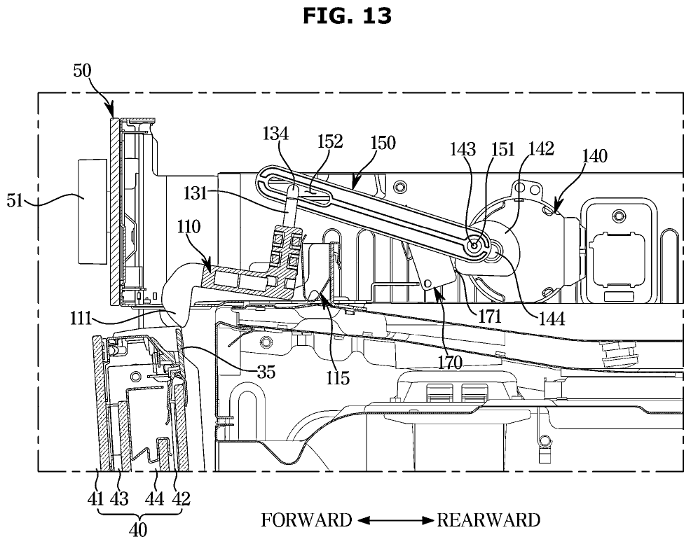

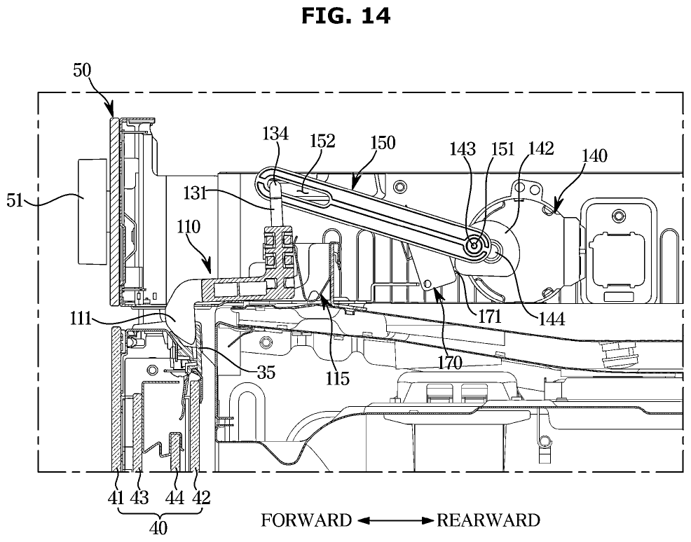

FIG. 12 is a cross-sectional view taken along A-A of FIG. 1, showing a condition before the door contacts the hook member when the open door is closed. FIG. 13 is a cross-sectional view taken along A-A of FIG. 1, showing a condition in which the hook member is rotated by the door when the open door is closed. FIG. 14 is a cross-sectional view taken along A-A of FIG. 1, showing a condition in which the door is closed and the door opening device holds the door to the main body.

In the following, with reference to FIGS. 12 to 14, an operation of the door opening device 100 when the door 40 of the cooking apparatus 1 according to the present disclosure is closed will be described in detail. FIGS. 12 to 14 show cross-sectional views of the first hook member 110, and thus the operation of the first hook member 110 will be described. The second hook member 120 may operate identically to the first hook member 110, and a description thereof will be omitted.

Referring to FIGS. 12 to 14, in contrast to when the door 40 is opened by the door opening device 100, the drive motor 140 may not operate when the door 40 is closed. Because the drive motor 140 does not operate, the drive shaft 141 and the cam member 142 may not rotate.

Referring to FIGS. 12 and 13, in response to the door 40 being closed, the first hook insertion portion 35 may press the first hook 111 such that the first hook 111 rotates in the second direction opposite to the first direction. In response to the first hook insertion portion 35 pressing the first hook 111, the first hook member 110 may rotate in the second direction. When the first hook member 110 rotates in the second direction, the cam member 142 may not rotate. In response to the rotation of the first hook member 110 in the second direction, the link coupling portion 134 of the connecting member 130 may move from one end of the connecting member insertion portion 152 of the link member 150 toward the other end. In response to the rotation of the first hook member 110 in the second direction, the first elastic member 115 may be pressed to accumulate elastic force.

Referring to FIG. 14, the first hook member 110 may be rotated in the second direction by the elastic force of the first elastic member 115. In response to the rotation of the first hook member 110 in the second direction, the first hook 111 may be inserted into the first hook insertion portion 35. Based on the first hook 111 being inserted into the first hook insertion portion 35, the link coupling portion 134 may be positioned at one end of the connecting member insertion portion 152. After the first hook 111 is inserted into the first hook insertion portion 35, the door 40 may be held to the main body 10, as described above. In other words, the door 40 may be maintained in the closed state.

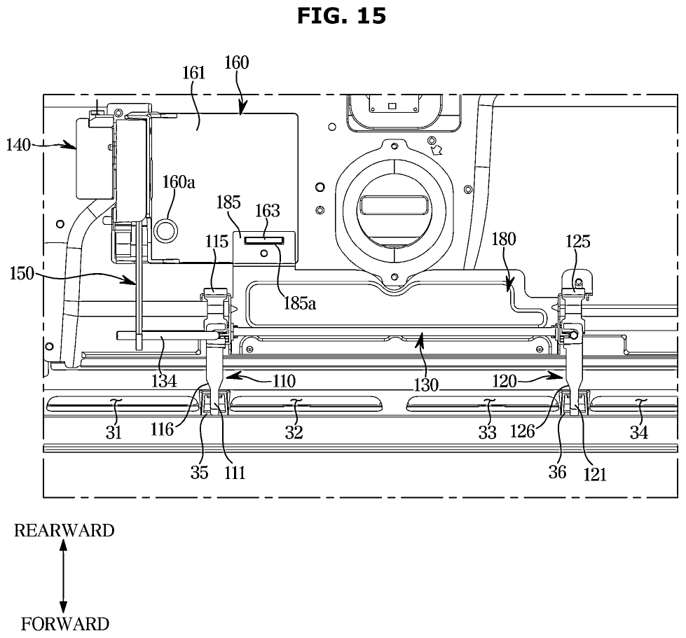

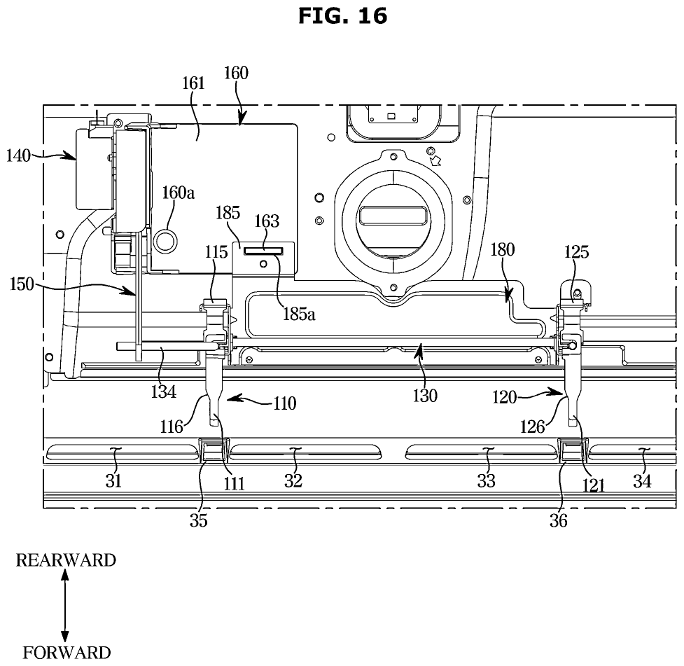

FIG. 15 is a plan view of portion B of FIG. 3, showing a condition before the door is opened. FIG. 16 is a plan view of portion B of FIG. 3, showing a condition after the door is unlocked.

Referring to FIG. 15, the cooking apparatus 1 according to an embodiment may include the first hook member 110 and the second hook member 120, and the first hook insertion portion 35 and the second hook insertion portion 36.

As described above, the door 40 may include the first to fourth air holes 31, 32, 33 and 34 formed in the door duct 45. The first to fourth air holes 31, 32, 33 and 34 may be arranged to be laterally spaced apart from the upper end of the door 40. The outside air introduced through the lower end of the door 40 may be heated between the outer glass 41 and the inner glass 42 and moved upwardly, and may be discharged to the upper end of the door 40 through the first to fourth air holes 31, 32, 33 and 34.

The first hook insertion portion 35 and the second hook insertion portion 36 may each be arranged so as not to obstruct the flow of air discharged through the first to fourth air holes 31, 32, 33 and 34. The first hook insertion portion 35 may be positioned between the first air hole 31 and the second air hole 32 to avoid interfering with the door cooling air flow discharged through the first to fourth air holes 31, 32, 33 and 34. The second hook insertion portion 36 may be positioned between the third air hole 33 and the fourth air hole 34 to avoid interfering with the door cooling airflow discharged through the first to fourth air holes 31, 32, 33 and 34.

Referring to FIGS. 15 and 16, the first hook member 110 and the second hook member 120 may each be provided in a shape that reduces interference with the flow of air discharged through the first to fourth air holes 31, 32, 33 and 34.

Specifically, the first hook 111 of the first hook member 110 and the second hook 121 of the second hook member 120 may be arranged to narrow in width closer to the front thereof. The first hook member 110 may include a first inclined portion 116 in which the width of the first hook member 110 narrows closer to the front thereof. The second hook member 120 may include a second inclined portion 126 in which the width of the second hook member 120 narrows closer to the front thereof. With respect to the first inclined portion 116, the width of the first hook member 110 at the rear side of the first inclined portion 116 may be greater than the width of the first hook member 110 at the front side of the first inclined portion 116. Similarly, with respect to the second inclined portion 126, the width of the second hook member 120 at the rear side of the second inclined portion 126 may be greater than the width of the second hook member 120 at the front side of the second inclined portion 126. The widths of the first hook member 110 and the second hook member 120 may refer to their lengths in a left-to-right direction, with respect to FIGS. 15 and 16.

By providing the first inclined portion 116 on the first hook member 110, the width of the first hook 111 inserted into the first hook insertion portion 35 may be reduced. By reducing the width of the first hook 111 inserted into the first hook insertion portion 35, the width of the first hook insertion portion 35 may be reduced. As the widths of the first hook insertion portion 35 and the first hook 111 inserted into the first hook insertion portion 35 are reduced, the interference between the first hook insertion portion 35 and the first hook 111, and the door cooling airflow discharged through the first air hole 31 and the second air hole 32 may be reduced. In other words, the area in which the first hook insertion portion 35 and the first hook 111 are not arranged or arranged on the flow path of the air discharged through the first air hole 31 and the second air hole 32 may be minimized.

By providing the second inclined portion 126 on the second hook member 120, the width of the second hook 121 inserted into the second hook insertion portion 36 may be reduced. By reducing the width of the second hook 121 inserted into the second hook insertion portion 36, the width of the second hook insertion portion 36 may be reduced. As the widths of the second hook insertion portion 36 and the second hook 121 inserted into the second hook insertion portion 36 are reduced, the interference between the second hook insertion portion 36 and the first hook 121, and the door cooling airflow discharged through the third air hole 33 and the fourth air hole 34 may be reduced. In other words, the area in which the second hook insertion portion 36 and the second hook 121 are not arranged or arranged on the flow path of the air discharged through the third air hole 33 and the fourth air hole 34 may be minimized.

With such a structure, the first hook insertion portion 35 and the first hook 111 and the second hook insertion portion 36 and the second hook 121 may not obstruct the flow of air discharged through the first to fourth air holes 31, 32, 33 and 34 without being arranged at either end of the upper portion of the door 40 where the first to fourth air holes 31, 32, 33 and 34 are not formed. In addition, the door 40 may be cooled smoothly without the first hook insertion portion 35 and the first hook 111 and the second hook insertion portion 36 and the second hook 121 being arranged on either end of the upper portion of the door 40 where the first to fourth air holes 31, 32, 33 and 34 are not formed.

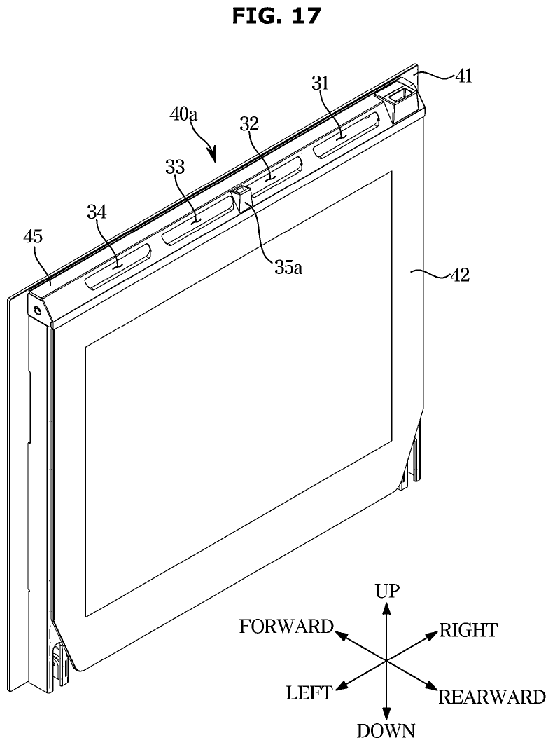

FIG. 17 is a view of a door alone in the cooking apparatus according to an embodiment.

Referring to FIG. 17, a door 40a of the cooking apparatus 1 according to an embodiment may include one hook insertion portion 35a. The hook insertion portion 35a may be positioned between the second air hole 32 and the third air hole 33. By being positioned between the second air hole 32 and the third air hole 33, the hook insertion portion 35a may not interfere with the airflow discharged through the second air hole 32 and the third air hole 33.

Although not shown in the drawing, the door opening device may include one hook member corresponding to the hook insertion portion 35a. The position of the hook member may be arranged to correspond to the hook insertion portion 35a.

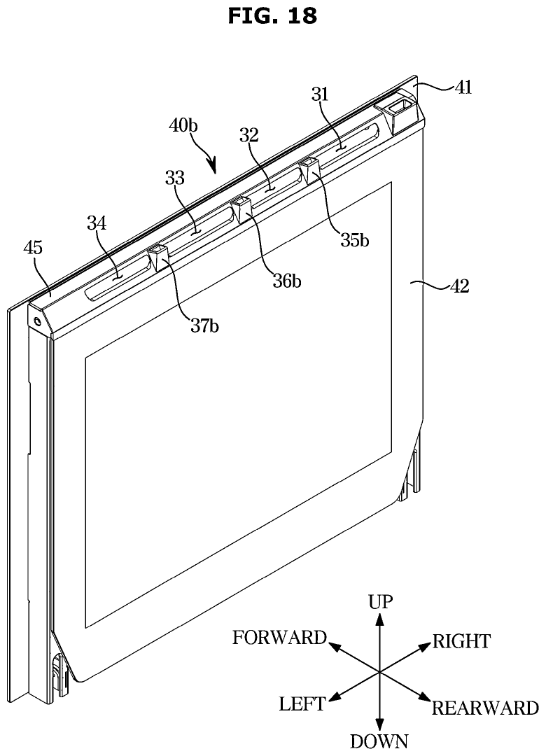

FIG. 18 is a view of a door alone in the cooking apparatus according to an embodiment.

Referring to FIG. 18, a door 40b of the cooking apparatus 1 according to an embodiment may include three hook insertion portions 35b, 36b and 37b.

The hook insertion portions 35b, 36b and 37b may include a first hook insertion portion 35b, a second hook insertion portion 36b, and a third hook insertion portion 37b.

The first hook insertion portion 35b may be positioned between the first air hole 31 and the second air hole 32. The second hook insertion portion 36b may be positioned between the second air hole 32 and the third air hole 33. The third hook insertion portion 37b may be positioned between the third air hole 33 and the fourth air hole 34.

The hook insertion portion 35b, 36b and 37b may be arranged between the first to fourth air holes 31, 32, 33 and 34, such that the hook insertion portion 35b, 36b and 37b may not interfere with the airflow discharged through the first to fourth air holes 31, 32, 33 and 34.

Although not shown in the drawing, the door opening device may include three hook members corresponding to the hook insertion portions 35b, 36b and 37b. The positions of the hook members may be arranged to correspond to the first hook insertion portion 35b, the second hook insertion portion 36b, and the third hook insertion portion 37b, respectively.

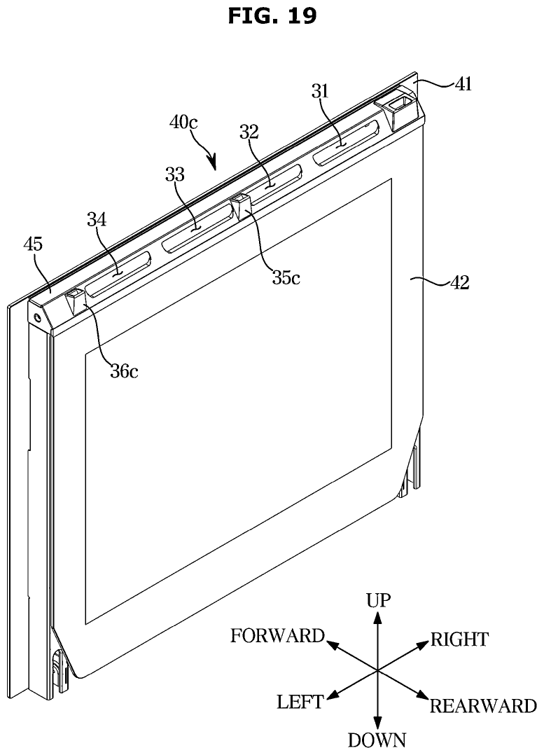

FIG. 19 is a view of a door alone in the cooking apparatus according to an embodiment.

Referring to FIG. 19, a door 40c of the cooking apparatus 1 according to an embodiment may include two hook insertion portions 35c and 36c.

The hook insertion portions 35c and 36c may include a first hook insertion portion 35c and a second hook insertion portion 36c.

The first hook insertion portion 35c may be positioned between the second air hole 32 and the third air hole 33. The second hook insertion portion 36c may be positioned next to the fourth air hole 34 as one end of the door duct 45.

By being positioned between the second air hole 32 and the third air hole 33, the first hook insertion portion 35c may not interfere with the airflow discharged through the second air hole 32 and the third air hole 33.

The second hook insertion portion 36c may be positioned next to the fourth air hole 34, so that it may not interfere with the airflow discharged through the fourth air hole 34.

Although not shown in the drawing, the door opening device may include two hook members corresponding to the hook insertion portions 35c and 36c. The positions of the hook members may be arranged to correspond to the first hook insertion portion 35c and the second hook insertion portion 36c, respectively.

In addition, contrary to what is shown in the drawing, the second hook insertion portion 36c may be positioned next to the first air hole 31 as the other end of the door duct 45.

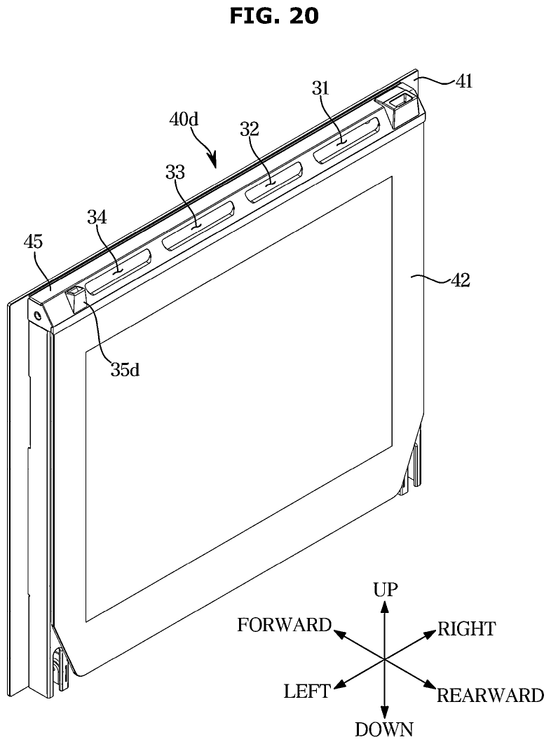

FIG. 20 is a view of a door alone in the cooking apparatus according to an embodiment.

Referring to FIG. 20, a door 40d of the cooking apparatus 1 according to an embodiment may include one hook insertion portion 35d. The hook insertion portion 35d may be positioned next to the fourth air hole 34 as one end of the door duct 45. By being positioned next to the fourth air hole 34, the hook insertion portion 35d may not interfere with the airflow discharged through the fourth air hole 34.

Although not shown in the drawing, the door opening device may include one hook member corresponding to the hook insertion portion 35d. The position of the hook member may be arranged to correspond to the hook insertion portion 35d.

In addition, contrary to what is shown in the drawing, the hook insertion portion 35d may be positioned next to the first air hole 31 as the other end of the door duct 45.

FIG. 21 is a control block diagram of a cooking apparatus according to an embodiment.

In an embodiment, the controller 191 may include at least one memory 191b storing data in the form of algorithms and/or programs for controlling the operation of configurations in the cooking apparatus 1, and at least one processor 191a performing the operations described above and operations described later using the data stored in the at least one memory 191b. The memory 191b and the processor 191a may each be implemented on separate chips. The processor 191a may include one or two or more processor chips or one or two or more processing cores. The memory 191b may include one or two or more memory chips or one or two or more memory blocks. In addition, the memory 191b and the processor 191a may also be implemented on a single chip.

The controller 191 may process user input received via an input device 190 and control various configurations of the cooking apparatus 1 (e.g., the drive motor 140, the display portion 52, a voice output device 54) based on the processing of the user input.

The input device 190 may include the operating portion 51 and the door opening button 53.

The controller 191 may control various configurations (e.g., the drive motor 140, the display portion 52, the voice output device 54) of the cooking apparatus 1 based on signals received via the input device 190 or the switch 170.

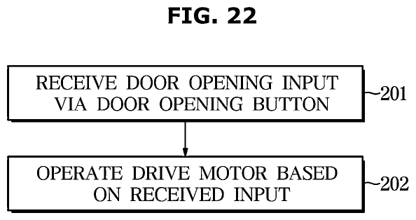

FIG. 22 is a flowchart of a method of controlling the cooking apparatus according to an embodiment.

Referring to FIG. 22, the controller 191 may receive a door opening input from the user via the door opening button 53 (201). The controller 191 may control the drive motor 140 to operate based on the received door opening input (202).

In response to the operation of the drive motor 140, the door 40 may open as described in association with FIGS. 9 to 11.

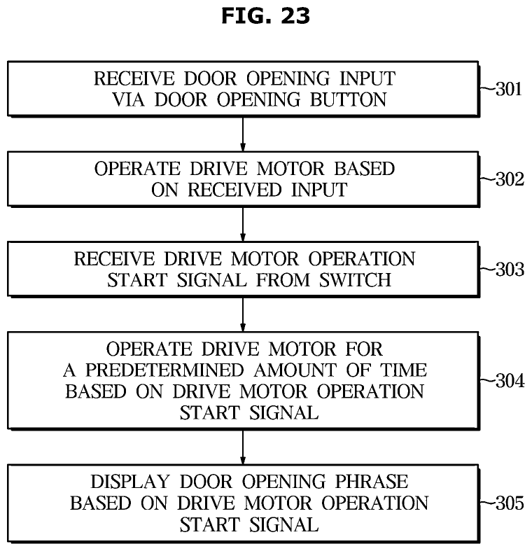

FIG. 23 is a flowchart of a method of controlling the cooking apparatus according to an embodiment.

Referring to FIG. 23, the controller 191 may receive a door opening input from the user via the door opening button 53 (301). The controller 191 may control the drive motor 140 to operate the drive motor 140 based on the received door opening input (302).

In response to the operation of the drive motor 140, the door 40 may open as described in association with FIGS. 9 to 11. In response to the operation of the drive motor 140, the switch protrusion 171 inserted inwardly into the switch 170 may protrude outwardly from the switch 170. In response to the switch protrusion 171 protruding outwardly from the switch 170, the switch 170 may transmit a drive motor operation start signal to the controller 191. The controller 191 may receive the drive motor operation start signal from the switch 170 (303).

The controller 191 may control the drive motor 140 to operate the drive motor 140 for a predetermined amount of time based on the drive motor operation start signal received from the switch 170 (304). The controller 191 may control the drive motor 140 to operate the drive motor 140 for the predetermined amount of time.

The controller 191 may control the display portion 52 to cause the display portion 52 to display a door opening phrase based on the drive motor operation start signal received from the switch 170 (305). For example, the controller 191 may control the display portion 52 to display the phrase “the door is opening.” on the display portion 52.

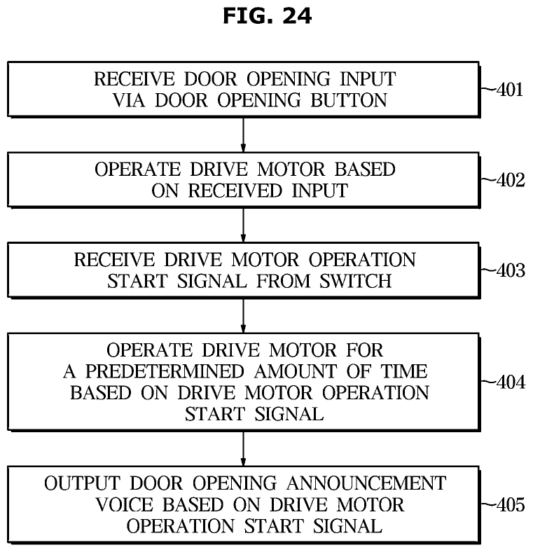

FIG. 24 is a flowchart of a method of controlling the cooking apparatus according to an embodiment.

Referring to FIG. 24, the controller 191 may receive a door opening input from the user via a door opening button 53 (401). The controller 191 may control the drive motor 140 to operate the drive motor 140 based on the received door opening input (402).

In response to the operation of the drive motor 140, the door 40 may open as described in association with FIGS. 9 to 11. In response to the operation of the drive motor 140 operates, the switch protrusion 171 inserted inwardly into the switch 170 may protrude outwardly from the switch 170. In response to the switch protrusion 171 protruding outwardly from the switch 170, the switch 170 may transmit a drive motor operation start signal to the controller 191. The controller 191 may receive the drive motor operation start signal from the switch 170 (403).

The controller 191 may control the drive motor 140 to operate the drive motor 140 for a predetermined amount of time based on the drive motor operation start signal received from the switch 170 (404). The controller 191 may control the drive motor 140 to operate the drive motor 140 for the predetermined amount of time.

The controller 191 may control the voice output device 54 to cause the voice output device 54 to output a door opening announcement voice based on the drive motor operation start signal received from the switch 170 (405). For example, the controller 191 may control the voice output device 54 to output the voice “The door is opening.”

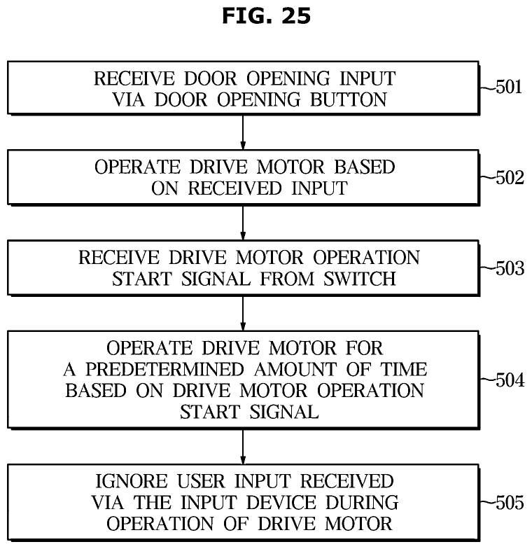

FIG. 25 is a flowchart of a method of controlling the cooking apparatus according to an embodiment.

Referring to FIG. 25, the controller 191 may receive a door opening input from the user via the door opening button 53 (501). The controller 191 may control the drive motor 140 to operate the drive motor 140 based on the received door opening input (502).

In response to the operation of the drive motor 140, the door 40 may open as described in association with FIGS. 9 to 11. In response to the operation of the drive motor 140, the switch protrusion 171 inserted inwardly into the switch 170 may protrude outwardly from the switch 170. In response to the switch protrusion 171 protruding outwardly from the switch 170, the switch 170 may transmit a drive motor operation start signal to the controller 191. The controller 191 may receive the drive motor operation start signal from the switch 170 (503).

The controller 191 may control the drive motor 140 to operate the drive motor 140 for a predetermined amount of time based on the drive motor operation start signal received from the switch 170 (504). The controller 191 may control the drive motor 140 to operate the drive motor 140 for the predetermined amount of time.

The controller 191 may ignore user input received via the input device 190 during operation of the drive motor 140 (505). The controller 191 may ignore user input via the operating portion 51 or the door opening button 53 while the drive motor 140 is operating to open the door 40. This may limit the user's control of the cooking apparatus 1 via the input device 191 while the drive motor 140 is operating to open the door 40.

The cooking apparatus 1 according to an embodiment may include the main body 10 including the cooking chamber 11 and the electrical chamber 21 partitioned from the cooking chamber at an upper side of the cooking chamber, the door 40 configured to open or close the cooking chamber, the door including the hook insertion portions 35 and 36 and the plurality of air holes 31, 32, 33 and 34 through which air passing through the interior of the door is discharged, and the door opening device 100 arranged in the electrical chamber and configured to open the door, the door opening device including the hook members 110 and 120 inserted into the hook insertion portion to lock the door to the main body and withdrawn from the hook insertion portion to unlock the door from the main body, and the drive motor 140 configured to provide a driving force to allow the hook member to be withdrawn from the hook insertion portion.

The hook insertion portion may be positioned between the plurality of air holes so as not to interfere with airflow discharged from the plurality of air holes.

The door opening device may further include the cam member 142 coupled to the drive shaft 141 of the drive motor and configured to rotate together with the drive shaft.

The door opening device may further include the link member 150 connecting the cam member and the hook member to allow the hook member to rotate in response to rotation of the cam member.

The door opening device may further include the connecting member 130 coupled to the hook member and the link member and configured to rotate the hook member in response to movement of the link member.

The cooking apparatus 1 may further include the controller 191 for controlling the door opening device.

The door opening device may further include the switch 170 configured to transmit a predetermined signal to the controller and including the switch protrusion 171 configured to be pushable.

The switch protrusion may be configured to be intermittently pushed by the cam member in response to the rotation of the cam member.

The hook member may include the inclined portions 116 and 126, wherein the width of the inclined portions narrows closer to the front thereof in a left-to-right direction of the hook member.

The hook member may be configured to be withdrawn from the hook insertion portion by rotating in a first direction.

The door opening device may further include the elastic members 115 and 125 that elastically bias the hook member in a second direction opposite to the first direction.

In response to closing the door, the hook member may be configured to rotate in the first direction by being pressed by the hook insertion portion and then to rotate in the second direction by an elastic force of the elastic member, thereby being inserted into the hook insertion portion.

The door opening device may further include the link member 150 configured to be connected to the drive shaft of the drive motor and transmit the driving force of the drive motor to the hook member, the link member 150 including the connecting member insertion portion 152.

The door opening device may further include the connecting member 130 including the link coupling portion 134 inserted into the connecting member insertion portion so as to be movable between one end and the other end of the connecting member insertion portion, the connecting member coupled to the hook member.

The elastic member may be configured to provide an elastic force to allow the link coupling portion to move toward the one end of the connecting member insertion portion.

Based on the hook member being rotated in the first direction by the drive motor, the link coupling portion may be positioned at the one end of the connecting member insertion portion.

Based on the hook member being rotated in the first direction by being pressed by the hook insertion portion, the link coupling portion may be moved from the one end to the other end of the connecting member insertion portion.

The hook insertion portion may include a first hook insertion portion and a second hook insertion portion arranged to be spaced apart laterally from an upper end of the door.

The hook member may include a first hook member configured to be inserted into the first hook insertion portion, and a second hook member configured to be inserted into the second hook insertion portion.

The plurality of air holes may include a first air hole, a second air hole, a third air hole, and a fourth air hole arranged to be laterally spaced apart from the upper end of the door.

The first hook insertion portion may be positioned between the first air hole and the second air hole so as not to interfere with the airflow discharged from the first air hole and the second air hole.

The second hook insertion portion may be positioned between the third air hole and the fourth air hole so as not to interfere with the airflow discharged from the third air hole and the fourth air hole.

The door opening device may further include the connecting member 130 connecting the first hook member and the second hook member to allow the first hook member and the second hook member to rotate together.

The cooking apparatus 1 according to an embodiment may include the main body 10 including the cooking chamber 11 and the electrical chamber 21 partitioned from the cooking chamber at an upper side of the cooking chamber; the door 40 configured to open or close the cooking chamber, the door including the first hook insertion portion 35 and the second hook insertion portion 36, and the door opening device arranged in the electrical chamber and configured to open the door.

The door opening device may include the drive motor 140 configured to rotate the drive shaft 141.

The door opening device may include the first hook member 110 inserted into the first hook insertion portion to hold the door to the main body and be withdrawn from the first hook insertion portion to release the door from the main body.

The door opening device may include the second hook member 120 inserted into the second hook insertion portion to hold the door to the main body and be withdrawn from the second hook insertion portion to release the door from the main body.

The door opening device may include the connecting member 130 connecting the first hook member and the second hook member to allow the first hook member and the second hook member to rotate together.

The door opening device may include the link member 150 connecting the drive shaft and the connecting member to allow the first hook member and the second hook member to rotate in response to rotation of the drive shaft.

The cooking apparatus 1 may further include the controller 191 for controlling the door opening device.

The door opening device may further include the cam member 142 coupled to the drive shaft to rotate together with the drive shaft and connected to the link member.

The door opening device may further include the switch 170 configured to transmit a predetermined signal to the controller and including the switch protrusion 171 configured to be pushable.

The switch protrusion may be configured to be intermittently pushed by the cam member in response to the rotation of the cam member.

The first hook member may include the first inclined portion 116, wherein a width of the first inclined portion narrows closer to the front thereof in a left-to-right direction of the first hook member.

The second hook member may include the second inclined portion 126, wherein a width of the second inclined portion narrows closer to the front thereof in the left-right direction of the second hook member.

The first hook member may be configured to be withdrawn from the first hook insertion portion by rotating in a first direction.

The second hook member may be configured to be withdrawn from the second hook insertion portion by rotating in the first direction.

The door opening device may further include the first elastic member 115 that elastically biases the first hook member in a second direction opposite to the first direction, and the second elastic member 125 that elastically biases the second hook member in the second direction.

In response to closing of the door, the first hook member may be configured to be pressed by the first hook insertion portion to rotate in the first direction, and then to rotate in the second direction by the elastic force of the first elastic member, thereby being inserted into the first hook insertion portion.

In response to closing of the door, the second hook member may be configured to be pressed by the second hook insertion portion to rotate in the first direction, and then to rotate in the second direction by the elastic force of the second elastic member, thereby being inserted into the second hook insertion portion.

According to one aspect of the disclosure, the cooking apparatus including the door having improved aesthetics may be provided by removing the door handle.

According to one aspect of the disclosure, the cooking apparatus including the door capable of opening automatically may be provided.

According to one aspect of the disclosure, the cooking apparatus having an improved structure such that a structure for holding the door to the main body does not interfere with the cooling of the door may be provided.

According to one aspect of the disclosure, the cooking apparatus may be provided with the plurality of hook insertion portions and the plurality of hook members to enable the door to be stably held to the main body.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. A cooking apparatus comprising:
a main body including:
a cooking chamber; and
an electrical chamber partitioned from the cooking chamber at an upper side of the cooking chamber;
a door configured to open or close the cooking chamber, the door including:
a hook insertion portion; and
a plurality of air holes through which air passing through an interior of the door is discharged; and
a door opening device arranged in the electrical chamber and configured to open the door, the door opening device including:
a hook member to be inserted into the hook insertion portion to lock the door to the main body and to be withdrawn from the hook insertion portion to unlock the door from the main body; and
a drive motor configured to apply a driving force to allow the hook member to be withdrawn from the hook insertion portion,
wherein the hook insertion portion is positioned between the plurality of air holes so as not to interfere with an airflow discharged from the plurality of air holes.

2. The cooking apparatus of claim 1, wherein the drive motor includes a drive shaft, and the door opening device further comprises:
a cam member coupled to the drive shaft and configured to rotate together with the drive shaft, and
a link member connecting the cam member to the hook member to allow the hook member to rotate in response to a rotation of the cam member.

3. The cooking apparatus of claim 2, wherein the door opening device further comprises a connecting member coupled to the hook member and the link member, the connecting member configured to rotate the hook member in response to a movement of the link member.

4. The cooking apparatus of claim 2, further comprising a controller configured to control the door opening device,
wherein the door opening device further comprises a switch configured to transmit a predetermined signal to the controller and including a switch protrusion configured to be pushable.

5. The cooking apparatus of claim 4, wherein the switch protrusion is configured to be intermittently pushed by the cam member in response to the rotation of the cam member.

6. The cooking apparatus of claim 1, wherein the hook member comprises an inclined portion having a width in a left-to-right direction of the hook member that narrows toward a forward.

7. The cooking apparatus of claim 1, wherein
the hook member is configured to be withdrawn from the hook insertion portion by rotating in a first direction, and
the door opening device further comprises an elastic member that elastically biases the hook member in a second direction opposite to the first direction.

8. The cooking apparatus of claim 7, wherein, in response to closing the door, the hook member is configured to rotate in the first direction by being pressed by the hook insertion portion and then to rotate in the second direction by an elastic force of the elastic member, thereby being inserted into the hook insertion portion.

9. The cooking apparatus of claim 7, wherein the door opening device further comprises:
a link member configured to be connected to a drive shaft of the drive motor and transmit the driving force of the drive motor to the hook member, the link member including a connecting member insertion portion; and
a connecting member including a link coupling portion inserted into the connecting member insertion portion so as to be movable between one end and an other end of the connecting member insertion portion, the connecting member coupled to the hook member, and
wherein the elastic member is configured to provide an elastic force to allow the link coupling portion to move toward the one end of the connecting member insertion portion.

10. The cooking apparatus of claim 9, wherein
based on the hook member being rotated in the first direction by the drive motor, the link coupling portion is positioned at the one end of the connecting member insertion portion, and
based on the hook member being rotated in the first direction by being pressed by the hook insertion portion, the link coupling portion is moved from the one end to the other end of the connecting member insertion portion.

11. The cooking apparatus of claim 1, wherein
the hook insertion portion comprises a first hook insertion portion and a second hook insertion portion arranged to be spaced apart laterally from an upper end of the door, and
the hook member comprises:
a first hook member configured to be inserted into the first hook insertion portion; and
a second hook member configured to be inserted into the second hook insertion portion.

12. The cooking apparatus of claim 11, wherein the plurality of air holes comprises a first air hole, a second air hole, a third air hole, and a fourth air hole arranged to be laterally spaced apart from the upper end of the door.

13. The cooking apparatus of claim 12, wherein
the first hook insertion portion is positioned between the first air hole and the second air hole so as not to interfere with an airflow discharged from the first air hole and the second air hole, and
the second hook insertion portion is positioned between the third air hole and the fourth air hole so as not to interfere with an airflow discharged from the third air hole and the fourth air hole.

14. The cooking apparatus of claim 11, wherein the door opening device further comprises a connecting member configured to connect the first hook member and the second hook member to allow the first hook member and the second hook member to rotate together.

15. A cooking apparatus comprising:
a main body including:
a cooking chamber; and
an electrical chamber partitioned from the cooking chamber at an upper side of the cooking chamber;
a door configured to open or close the cooking chamber, the door including:
a first hook insertion portion; and
a second hook insertion portion; and
a door opening device arranged in the electrical chamber and configured to open the door, the door opening device comprising:
a drive shaft;
a drive motor configured to rotate a drive shaft;
a first hook member to be inserted into the first hook insertion portion to hold the door to the main body and to be withdrawn from the first hook insertion portion to release the door from the main body;
a second hook member to be inserted into the second hook insertion portion to hold the door to the main body and to be withdrawn from the second hook insertion portion to release the door from the main body;
a connecting member connecting the first hook member and the second hook member to allow the first hook member and the second hook member to rotate together; and
a link member connecting the drive shaft and the connecting member to allow the first hook member and the second hook member to rotate in response to a rotation of the drive shaft.
